(19) United States
(12) Patent Application Publication
(10) Pub. No.: US 2022/0204388 A1
(43) Pub. Date: Jun. 30, 2022

(54) CHEMICALLY DURABLE, LITHIUM-FREE GLASS COMPOSITIONS

(71) Applicant: CORNING INCORPORATED, CORNING, NY (US)

(72) Inventors: Venkatesh Botu, Corning, NY (US); Matthew John Dejneka, Corning, NY (US); Nadja Teresia Lönnroth, Helsinki (FI); Adama Tandia, Corning, NY (US); Kochuparambil Deenamma Vargheese, Horseheads, NY (US)

(21) Appl. No.: 17/606,665

(22) PCT Filed: Apr. 28, 2020
(86) PCT No.: PCT/US2020/030172

§ 371 Date: Oct. 26, 2021

Related U.S. Application Data
(60) Provisional application No. 62/840,711, filed on Apr. 30, 2019.

(51) Int. Cl. C03C 4/20; C03C 3/118; C03C 3/093

(52) U.S. Cl. CPC C03C 4/20; C03C 3/093; C03C 3/118

(57) ABSTRACT

Chemically durable glass compositions are disclosed. In embodiments, the glass composition includes: 48 mol. % to 61 mol. % SiO₂; 0 mol. % to 1 mol. % Al₂O₃; 7 mol. % to 20 mol. % B₂O₃; 9 mol. % to 16 mol. % R₂O, where R₂O is a sum of alkali oxides present in the glass composition; 9 mol. % to 15 mol. % Na₂O; and 8 mol. % to 21 mol. % ZnO. The glass composition may be substantially free of Li₂O. RO (mol. %)<0.5×ZnO (mol. %), where RO is a sum of the alkaline earth oxides in the glass composition. An average coefficient of thermal expansion of the glass composition is 75×10⁻⁷/° C. to 88×10⁻⁷/° C. over a temperature range from about 20° C. to about 300° C. The glass composition comprises a softening point less than or equal to 660° C. The glass composition comprises a hydrolytic resistance of class HGA1 or class HGA2 according to ISO 720:1985.

### CROSS-REFERENCE TO RELATED APPLICATIONS

This application claims the benefit of priority under 35 U.S.C. § 119 of U.S. Provisional Application No. 62/840,711 filed Apr. 30, 2019, the content of which is incorporated herein by reference in its entirety.

### BACKGROUND

### Field

The present specification generally relates to chemically durable glass compositions and, more particularly, to chemically durable glass compositions having good hydrolytic resistance and which are substantially free of lithium and lithium containing compounds.

### Technical Background

Glass is widely employed in a variety of products ranging from consumer electronic devices to pharmaceutical packaging materials due to its optical characteristics, ability to form and maintain hermetic seals, and/or relative inertness.

As the adoption of glass in various products has increased, so too has the need to provide glass compositions capable of being formed or shaped into complex geometries. However, the properties of glass which make it a desirable material for certain applications may also hamper the ability to form the glass into complex, 3-dimensional shapes.

Accordingly, a need exists for alternative glass compositions which are chemically durable and can be readily remolded from stock form into 3-dimensional shapes.

### SUMMARY

According to a first Aspect A1, a glass composition may include: greater than or equal to 48 mol. % and less than or equal to 61 mol. % SiO₂; greater than or equal to 0 mol. % and less than or equal to 1 mol. % Al₂O₃; greater than or equal to 7 mol. % and less than or equal to 20 mol. % B₂O₃; greater than or equal to 9 mol. % and less than or equal to 16 mol. % R₂O, where R₂O is a sum of alkali oxides present in the glass composition; greater than or equal to 9 mol. % and less than or equal to 15 mol. % Na₂O; and greater than or equal to 8 mol. % and less than or equal to 21 mol. % ZnO, wherein: the glass composition is substantially free of Li₂O; RO (mol. %)<0.5×ZnO (mol. %), where RO is a sum of the alkaline earth oxides MgO, CaO, BaO, and SrO in the glass composition; an average coefficient of thermal expansion of the glass composition is greater than or equal to 75×10⁻⁷/° C. and less than or equal to 88×10⁻⁷/° C. over a temperature range from about 20° C. to about 300° C.; the glass composition comprises a softening point less than or equal to 660° C.; and the glass composition comprises a hydrolytic resistance of class HGA1 or class HGA2 according to ISO 720:1985.

A second aspect includes the glass composition according to the first aspect A1, wherein: SiO₂ is greater than or equal to 52 mol. % and less than or equal 61 mol. %; B₂O₃ is greater than or equal to 12 mol. % and less than or equal to 17 mol. %; and ZnO is greater than or equal to 8 mol. % and less than or equal to 16 mol. %.

A third aspect includes the glass composition according to the second aspect A2, wherein Al₂O₃ is greater than 0.1 mol. % and less than or equal to 1.0 mol. %.

A fourth aspect includes the glass composition according to the second aspect A2 or the third aspect A3, wherein Al₂O₃ is greater than 0.1 mol. % and less than or equal to 0.7 mol. %.

A fifth aspect A5 includes the glass composition of any of the second through fourth aspects A2-A5, wherein B₂O₃ is greater than or equal to 12 mol. % and less than or equal to 15 mol. %.

A sixth aspect A6 includes the glass composition of any of the second through fifth aspects A2-A5, wherein R₂O is less than or equal to 15 mol. %.

A seventh aspect A7 includes the glass composition of any of the second through sixth aspects A2-A6, wherein R₂O is less than or equal to 14 mol. %.

A eighth aspect A8 includes the glass composition of any of the second through seventh aspects A2-A7, wherein Na₂O is greater than or equal to 9 mol. % and less than or equal to 13 mol. %.

A ninth aspect A9 includes the glass composition of any of the second through eighth aspects A2-A8, wherein Na₂O is greater than or equal to 9 mol. % and less than or equal to 12 mol. %.

A tenth aspect A10 includes the glass composition of any of the second through ninth aspects A2-A9, wherein ZnO is greater than or equal to 9 mol. % and less than or equal to 15 mol. %.

An eleventh aspect A11 includes the glass composition of any of the second through tenth aspects A2-A10, comprising greater than or equal to 1 mol. % and less than or equal to 5 mol. % K₂O.

A twelfth aspect A12 includes the glass composition of any of the second through eleventh aspects A2-A11, further comprising greater than or equal to 1 mol. % and less than or equal to 2.5 mol. % K₂O.

A thirteenth aspect A13 includes the glass composition of any of the second through twelfth aspects A2-A12, wherein the glass composition is substantially free of K₂O.

A fourteenth aspect A14 includes the glass composition of any of the second through thirteenth aspects A2-A13, wherein RO is less than or equal to 5 mol. %.

A fifteenth aspect A15 includes the glass composition of any of the second through fourteenth aspects A2-A14, wherein a total amount of MgO (mol. %)+SrO (mol. %) is greater than or equal to 0.5 mol. % and less than or equal to 4 mol. %.

A sixteenth aspect A16 includes the glass composition of any of the second through fifteenth aspects A2-A15, further comprising greater than or equal to 0.5 mol. % and less than or equal to 2.5 mol. % SrO.

A seventeenth aspect A17 includes the glass composition of any of the second through sixteenth aspects A2-A16, further comprising greater than or equal to 0.5 mol. % and less than or equal to 2.0 mol. % SrO.

An eighteenth aspect A18 includes the glass composition of any of the second through seventeenth aspects A2-A17, wherein the glass composition is substantially free of SrO.

A nineteenth aspect A19 includes the glass composition of any of the second through eighteenth aspects A2-A18, further comprising greater than or equal to 0.5 mol. % and less than or equal to 2.5 mol. % MgO.

A twentieth aspect A20 includes the glass composition of any of the second through twenty-first aspects A2-A19, further comprising greater than or equal to 0.5 mol. % and less than or equal to 2.0 mol. % MgO.

A twenty-first aspect A21 includes the glass composition of any of the second through twentieth aspects A2-A20, wherein the glass composition is substantially free of MgO.

A twenty-second aspect A22 includes the glass composition of any of the second through twenty-first aspects A2-A21, wherein the glass composition comprises greater than 0.1 mol. % and less than or equal to 1.5 mol. % of at least one of TiO₂ and ZrO₂.

A twenty-third aspect A23 includes the glass composition of any of the second through twenty-second aspects A2-A22, wherein the glass composition comprises a liquidus viscosity of greater than 90 kilopoise (kP).

A twenty-fourth aspect A24 includes the glass composition of any of the second through twenty-third aspects A2-A23, wherein the glass composition comprises a molding temperature of less than 630° C.

A twenty-fifth aspect A25 includes the glass composition of any of the second through twenty-fourth aspects A2-A24, wherein the glass composition has a weight loss of less than or equal to 10 mg/cm² according to the base test.

A twenty-sixth aspect A26 includes the glass composition of any of the second through twenty-fifth aspects A2-A25, wherein the glass composition has a weight loss of less than or equal to 10 mg/cm² according to the acid test.

A twenty-seventh aspect A27 includes glass composition of the first aspect, wherein: SiO₂ is greater than or equal to 48 mol. % and less than or equal 55 mol. %; and ZnO is greater than or equal to 13 mol. % and less than or equal to 21 mol. %, wherein a ratio of ZnO (mol. %) to R₂O (mol. %) is greater than or equal to 0.75 and less than or equal to 2.0.

A twenty-eighth aspect A28 includes the glass composition of the twenty-seventh aspect A27, wherein the ratio of ZnO (mol. %) to R₂O (mol. %) is greater than or equal to 1.0.

A twenty-ninth aspect A29 includes the glass composition of any of the twenty-seventh through twenty-eighth aspects A27-A28, wherein SiO₂ is greater than or equal to 49 mol. % and less than or equal to 52 mol. %.

A thirtieth aspect A30 includes the glass composition of any of the twenty-seventh through twenty-ninth aspects A27-A29, wherein Al₂O₃ is greater than 0.1 mol. % and less than or equal to 1.0 mol. %.

A thirty-first aspect A31 includes the glass composition of any of the twenty-seventh through thirtieth aspects A27-A30, wherein Al₂O₃ is greater than 0.1 mol. % and less than or equal to 0.7 mol. %.

A thirty-second aspect A32 includes the glass composition of any of the twenty-seventh through thirty-first aspects A27-A31, wherein B₂O₃ is greater than or equal to 12 mol. % and less than or equal to 17 mol. %.

A thirty-third aspect A33 includes the glass composition of any of the twenty-seventh through thirty-second aspects A27-A32, wherein B₂O₃ is greater than or equal to 14 mol. % and less than or equal to 17 mol. %.

A thirty-fourth aspect A34 includes the glass composition of any of the twenty-seventh through thirty-third aspects A27-A33, wherein R₂O is less than or equal to 14 mol. %.

A thirty-fifth aspect A35 includes the glass composition of any of the twenty-seventh through thirty-fourth aspects A27-A34, wherein R₂O is less than or equal to 13 mol. %.

A thirty-sixth aspect A36 includes the glass composition of any of the twenty-seventh through thirty-fifth aspects A27-A35, wherein Na₂O is greater than or equal to 9 mol. % and less than or equal to 14 mol. %.

A thirty-seventh aspect A37 includes the glass composition of any of the twenty-seventh through thirty-sixth aspects A27-A36, wherein Na₂O is greater than or equal to 10 mol. % and less than or equal to 13 mol. %.

A thirty-eighth aspect A38 includes the glass composition of any of the twenty-seventh through thirty-seventh aspects A27-A37, wherein ZnO is greater than or equal to 14 mol. % and less than or equal to 20 mol. %.

A thirty-ninth aspect A39 includes the glass composition of any of the twenty-seventh through thirty-eighth aspects A27-A38, wherein ZnO is greater than or equal to 15 mol. % and less than or equal to 20 mol. %.

A fortieth aspect A40 includes the glass composition of any of the twenty-seventh through thirty-ninth aspects A27-A39 further comprising greater than or equal to 1 mol. % and less than or equal to 3 mol. % K₂O.

A forty-first aspect A41 includes the glass composition of any of the twenty-seventh through fortieth aspects A27-A40 further comprising greater than or equal to 1 mol. % and less than or equal to 2.5 mol. % K₂O.

A forty-second aspect A42 includes the glass composition of any of the twenty-seventh through forty-first aspects A27-A41, wherein the glass composition is substantially free of K₂O.

A forty-third aspect A43 includes the glass composition of any of the twenty-seventh through forty-second aspects A27-A42, wherein RO is less than or equal to 10 mol. %.

A forty-fourth aspect A44 includes the glass composition of any of the twenty-seventh through forty-third aspects A27-A43, wherein RO is less than or equal to 5 mol. %.

A forty-fifth aspect A45 includes the glass composition of any of the twenty-seventh through forty-fourth aspects A27-A44, wherein a total amount of MgO (mol. %)+SrO (mol. %) is greater than or equal to 0.5 mol. % and less than or equal to 10 mol. %.

A forty-sixth aspect A46 includes the glass composition of any of the twenty-seventh through forty-fifth aspects A27-A45, wherein a total amount of MgO (mol. %)+SrO (mol. %) is greater than or equal to 0.5 mol. % and less than or equal to 5 mol. %.

A forty-seventh aspect A47 includes the glass composition of any of the twenty-seventh through forty-sixth aspects A27-A46, wherein a total amount of MgO (mol. %)+SrO (mol. %) is greater than or equal to 0.5 mol. % and less than or equal to 2 mol. %.

A forty-eighth aspect A48 includes the glass composition of any of the twenty-seventh through forty-seventh aspects A27-A47 further comprising greater than or equal to 0.5 mol. % and less than or equal to 5.0 mol. % SrO.

A forty-ninth aspect A49 includes the glass composition of any of the twenty-seventh through forty-eighth aspects A27-A48 further comprising greater than or equal to 0.5 mol. % and less than or equal to 2.5 mol. % SrO.

A fiftieth aspect A50 includes the glass composition of any of the twenty-seventh through forty-ninth aspects A27-A49, wherein the glass composition is substantially free of SrO.

A fifty-first A51 includes the glass composition of any of the twenty-seventh through fiftieth aspects A27-A50 further comprising greater than or equal to 0.5 mol. % and less than or equal to 5.0 mol. % MgO.

A fifty-second aspect A52 includes the glass composition of any of the twenty-seventh through fifty-first aspects A27-A51 further comprising greater than or equal to 0.5 mol. % and less than or equal to 2.5 mol. % MgO.

A fifty-third aspect A53 includes the glass composition of any of the twenty-seventh through fifty-second aspects A27-A52, wherein the glass composition is substantially free of MgO.

A fifty-fourth aspect A54 includes the glass composition of any of the twenty-seventh through fifty-third aspects A27-A53 further comprising greater than or equal to 0.5 mol. % and less than or equal to 5.0 mol. % CaO.

A fifty-fifth aspect A55 includes the glass composition of any of the twenty-seventh through fifty-fourth aspects A27-A54 further comprising greater than or equal to 0.5 mol. % and less than or equal to 2.5 mol. % CaO.

A fifty-sixth aspect A56 includes the glass composition of any of the twenty-seventh through fifty-fifth aspects A27-A55, wherein the glass composition comprises greater than 0.1 mol. % and less than or equal to 1.5 mol. % of at least one of TiO₂ and ZrO₂.

A fifty-seventh aspect A57 includes the glass composition of any of the twenty-seventh through fifty-sixth aspects A27-A56, wherein the glass composition comprises a liquidus viscosity of greater than 1 kilopoise (kP) and less than or equal to 50 kP.

A fifty-eighth aspect A58 includes the glass composition of any of the twenty-seventh through fifty-seventh aspects A27-A57, wherein the glass composition comprises a molding temperature of less than 620° C.

A fifty-ninth aspect A59 includes the glass composition of any of the twenty-seventh through fifty-eighth aspects A27-A58, wherein the glass composition has a weight loss of less than or equal to 10 mg/cm² according to the base test.

A sixtieth aspect A60 includes the glass composition of any of the twenty-seventh through fifty-ninth aspects A27-A59, wherein the glass composition has a weight loss of less than or equal to 10 mg/cm² according to the acid test.

According to a sixty-first aspect A61, a glass composition includes greater than or equal to 66 mol. % and less than or equal to 74 mol. % SiO₂; greater than or equal to 3 mol. % and less than or equal to 7 mol. % Al₂O₃; greater than or equal to 11 mol. % and less than or equal to 23 mol. % R₂O, where R₂O is a sum of alkali oxide (mol. %) present in the glass composition; greater than or equal to 11 mol. % and less than or equal to 18 mol. % Na₂O; less than or equal 3.0 mol. % ZnO; and greater than 2.5 mol. % and less than or equal to 5 mol. % F₂, wherein: the glass composition is substantially free of Li₂O; an average coefficient of thermal expansion of the glass composition is greater than or equal to 80×10⁻⁷/° C. and less than or equal to 92×10⁻⁷/° C. over a temperature range from about 20° C. to about 300° C.; the glass composition comprises a softening point less than or equal to 680° C.; and the glass composition comprises a hydrolytic resistance of class HGA1 or class HGA2 according to ISO 720:1985.

A sixty-second aspect A62 includes the glass composition sixty-first aspect A61, wherein SiO₂ is greater than or equal to 70 mol. % and less than or equal to 73 mol. %.

A sixty-third aspect A63 includes the glass composition of any of the sixty-first through sixty-second aspects A61-A62, wherein Al₂O₃ is greater than or equal to 5 mol. % and less than or equal to 7 mol. %.

A sixty-fourth aspect A64 includes the glass composition of any of the sixty-first through sixty-third aspects A61-A63 further comprising greater than or equal to 0.1 mol. % and less than or equal to 6 mol. % B₂O₃.

A sixty-fifth aspect A65 includes the glass composition of any of the sixty-first through sixty-fourth aspects A61-A64 further comprising greater than or equal to 0.3 mol. % and less than or equal to 3 mol. % B₂O₃.

A sixty-sixth aspect A66 includes the glass composition of any of the sixty-first through sixty-fifth aspects A61-A65, wherein the glass composition is substantially free of P₂O₅.

A sixty-seventh aspect A67 includes the glass composition of any of the sixty-first through sixty-sixth aspects A61-A66, wherein Na₂O is greater than or equal to 12 mol. % and less than or equal to 16 mol. %.

A sixty-eighth aspect A68 includes the glass composition of any of the sixty-first through sixty-seventh aspects A61-A67 further comprising greater than or equal to 0.5 mol. % K₂O and less than or equal to 4 mol. % K₂O.

A sixty-ninth aspect A69 includes the glass composition of any of the sixty-first through sixty-eighth aspects A61-A68, wherein K₂O is greater than or equal to 0.75 mol. % and less than or equal to 1.5 mol. %.

A seventieth aspect A70 includes the glass composition of any of the sixty-first through sixty-ninth aspects A61-A69, wherein the glass composition comprises a liquidus viscosity of greater than 200 kilopoise (kP).

A seventy-first aspect A71 includes the glass composition of any of the sixty-first through seventieth aspects A61-A70, wherein the glass composition comprises a molding temperature of less than 620° C.

A seventy-second aspect A72 includes the glass composition of any of the sixty-first through seventy-first aspects A61-A71, wherein the glass composition has a weight loss of less than or equal to 10 mg/cm² according to the base test.

A seventy-third aspect A73 includes the glass composition of any of the sixty-first through seventy-second aspects A61-A72, wherein the glass composition has a weight loss of less than or equal to 10 mg/cm² according to the acid test.

Additional features and advantages of the glass compositions described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### DETAILED DESCRIPTION

Reference will now be made in detail to various embodiments of chemically durable, lithium-free glass compositions. According to one embodiment, a chemically durable glass composition includes: 48 mol. % to 61 mol. % SiO₂; 0 mol. % to 1 mol. % Al₂O₃; 7 mol. % to 20 mol. % B₂O₃; 9 mol. % to 16 mol. % R₂O, where R₂O is a sum of alkali oxides present in the glass composition; 9 mol. % to 15 mol. % Na₂O; and 8 mol. % to 21 mol. % ZnO. The glass composition may be substantially free of Li₂O. The glass composition may have an RO content that satisfies the relationship RO (mol. %)<0.5×ZnO (mol. %), where RO is a sum of the alkaline earth oxides in the glass composition. An average coefficient of thermal expansion of the glass composition is 75×10⁻⁷/° C. to 88×10⁻⁷/° C. over a temperature range from about 20° C. to about 300° C. The glass composition comprises a softening point less than or equal to 660° C. The glass composition comprises a hydrolytic resistance of class HGA1 or class HGA2 according to ISO 720:1985. Various embodiments of the glass compositions and the properties thereof will be described in further detail herein with specific reference to the illustrative examples.

The term “softening point,” as used herein, refers to the temperature at which the viscosity of the glass composition is 1×10^{7.6} poise.

The term “annealing point,” as used herein, refers to the temperature at which the viscosity of the glass composition is 1×10¹³ poise.

The terms “strain point” and “Tₛₜᵣₐᵢₙ” as used herein, refer to the temperature at which the viscosity of the glass composition is 3×10¹⁴ poise.

The term “molding temperature” as used herein, refers to the temperature at which the viscosity of the glass is 1×10^{8.8} poise.

The term “liquidus temperature,” as used herein, refers to the maximum temperature at which crystals can co-exist with molten glass in the glass melt in thermodynamic equilibrium.

The term “liquidus viscosity,” as used herein, refers to the viscosity of the glass at the onset of devitrification (i.e., at the liquidus temperature).

The term “CTE,” as used herein, refers to the coefficient of thermal expansion of the glass composition over a temperature range from about 20° C. to about 300° C.

In the embodiments of the glass compositions described herein, the concentrations of constituent components (e.g., Sift, Al₂O₃, and the like) are specified in mole percent (mol. %) on an oxide basis, unless otherwise specified.

The terms “free” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.05 mol. %.

The term “chemical durability,” as used herein, refers to the ability of the glass composition to resist degradation upon exposure to specified chemical conditions. Specifically, the chemical durability of the glass compositions described herein was assessed in acidic solutions, in basic solutions, and in water. The resistance of the glass to degradation in water was determined according to ISO 720:1985 entitled “Glass—Hydrolytic resistance of glass grains at 121 degrees C.—Method of test and classification.” The resistance of the glass to degradation in acid was measured by submerging a 2.54 cm×5.08 in.×1 mm thick sample of the glass composition in a solution of 5 wt. % HCl in water at 95° C. for 24 hours (hereinafter the acid test). The weight of the sample was measured before submersion and after submersion and the weight loss was determined per unit area (i.e., (initial weight−final weight)/total surface area (cm²)). Samples with a weight loss of less than 10 mg/cm² are considered to be resistant to degradation in acid. The resistance of the glass to degradation in a basic solution was measured by submerging a 2.54 cm×5.08 in.×1 mm thick sample of the glass composition in a solution of 5 wt. % NaOH in water at 95° C. for 6 hours (hereinafter the base test). The weight of the sample was measured before submersion and after submersion and the weight loss was determined per unit area (i.e., (initial weight−final weight)/total surface area (cm²)). Samples with a weight loss of less than 10 mg/cm² are considered to be resistant to degradation in basic solutions.

Strain and annealing points were measured according to the beam bending viscosity method which measures the viscosity of inorganic glass from 10¹² to 10¹⁴ poise as a function of temperature in accordance with ASTM C598.

Softening points and molding temperatures were measured according to the parallel place viscosity method which measures the viscosity of inorganic glass from 10⁷ to 10⁹ poise as a function of temperature, similar to the ASTM C1351M.

Liquidus temperatures were measured with the gradient furnace method according to ASTM C829-81.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the FIGURES as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Glass compositions in stock form (such as sheets, tubes, rods, boules, and the like) may be remolded to form finished glass articles having complex 3-dimensional shapes. For example and without limitation, tubes of glass stock may be remolded into glass containers for holding liquid product, sheets of glass may be remolded to form cover glasses for electronic devices or optical components (such as lenses, cones, or the like) which may be incorporated into electronic devices. As such, it is desirable that glass compositions have a relatively low softening point (and other relatively low characteristic temperatures such as the strain point, annealing point, and molding point) to facilitate remolding. In particular, relatively low characteristic temperatures increase the ease of remolding the glass compositions into a preferred form and also extend the service life of the molds which contact the glass. Specifically, relatively low characteristic temperatures of the glass being remolded reduces the temperature of the remolding process which, in turn, reduces the oxidation of metal parts of the mold and minimizes chemical reactions between the mold and the glass composition.

The characteristic temperatures of the glass may be decreased by adding lithium to the glass in the form of Li₂O, for example. However, it has been found that lithium ions in the glass are highly mobile which may have deleterious effects when the glass is used in certain applications. For example, when the finished glass article is intended for applications requiring contact with liquids, such as when the glass composition is used to form pharmaceutical containers or packages or when the glass composition is used for optical components that come into contact with liquids, the highly mobile lithium ions may leach out of the glass composition and into the liquid, degrading or otherwise changing the composition of the liquid. Alternatively or additionally, when the finished glass article is used in applications where a coating, such as a metallized coating, is applied to the finished glass article, lithium ions from the glass composition may migrate into the coating and degrade the properties of the coating.

Disclosed herein are two glass compositions spaces defining glass compositions which mitigate the aforementioned problems. Specifically, the glass compositions of these composition spaces have good hydrolytic resistance and relatively low characteristic temperatures such that the glass compositions may be readily softened and molded to a desired shape.

### Composition Space A: Lithium-Free, High ZnO Glass Compositions

The glass compositions in Composition Space A include a combination of SiO₂, B₂O₃, alkali oxides (R₂O), and ZnO which provides the glass compositions with relatively low coefficients of thermal expansion (e.g., less than or equal to 88×10⁻⁷/° C. over a temperature range from about 20° C. to about 300° C.), softening points less than or equal to 660° C., and hydrolytic resistances of class HGA1 or class HGA2 according to ISO 720:1985. Certain of these glasses within Composition Space A may have liquidus viscosities of greater than 90 kP such that the glasses are compatible with sheet-forming processes (e.g., fusion drawing processes, slot draw processes, and the like).

In the embodiments of the glass compositions of Composition Space A, SiO₂ is the largest constituent of the composition and, as such, is the primary constituent of the resulting glass network. That is, SiO₂ is the primary network former. SiO₂ enhances the chemical durability of the glass and, in particular, the resistance of the glass composition to decomposition in acid and the resistance of the glass composition to decomposition in water. Accordingly, a high SiO₂ concentration is generally desired. However, if the content of SiO₂ is too high, the formability of the glass may be diminished as higher concentrations of SiO₂ increase the difficulty of melting, softening, and molding the glass which, in turn, adversely impacts the formability of the glass. In embodiments of the glass compositions described herein, a lower amount of SiO₂ may be included in the glass composition to maintain the formability of the glass and additional constituents may be added to the glass to offset the reduction in chemical durability due to the relatively low amounts of SiO₂ contained in the glass.

In embodiments, the glass compositions of Composition Space A may include SiO₂ in an amount greater than or equal to 48 mol. %. The amount of SiO₂ may be less than or equal to 61 mol. % such that the glass compositions may be readily melted and formed. Accordingly, in embodiments of the glass compositions of Composition Space A, the glass compositions may comprise SiO₂ in an amount greater than or equal to 48 mol. % and less than or equal to 61 mol. %. In embodiments, the lower bound of the amount of SiO₂ in the glass composition may be greater than or equal to 48 mol. %, greater than or equal to 49 mol. %, greater than or equal to 50 mol. %, greater than or equal to 51 mol. %, greater than or equal to 52 mol. %, greater than or equal to 53 mol. %, or even greater than or equal to 54 mol. %. In embodiments, the upper bound of the amount of SiO₂ in the glass composition may be less than or equal to 61 mol. %, less than or equal to 60 mol. %, less than or equal to 59 mol. %, less than or equal to 58 mol. %, less than or equal to 57 mol. %, less than or equal to 56 mol. %, less than or equal to 55 mol. %, less than or equal to 54 mol. %, less than or equal to 53 mol. %, or even less than or equal to 52 mol. %. It should be understood that the amount of SiO₂ in the glass compositions may be within a range formed from any one of the lower bounds for SiO₂ and any one of the upper bounds of SiO₂ described herein.

For example and without limitation, in embodiments, the glass compositions of Composition Space A may include greater than or equal to 48 mol. % and less than or equal to 61 mol. % SiO₂. In embodiments, the glass composition may include greater than or equal to 49 mol. % and less than or equal to 61 mol. % SiO₂. In embodiments, the glass composition may include greater than or equal to 50 mol. % and less than or equal to 61 mol. % SiO₂. In embodiments, the glass composition may include greater than or equal to 51 mol. % and less than or equal to 61 mol. % SiO₂. In embodiments, the glass composition may include greater than or equal to 52 mol. % and less than or equal to 61 mol. % SiO₂. In embodiments, the glass composition may include greater than or equal to 52 mol. % and less than or equal to 61 mol. % SiO₂. In embodiments, the glass composition may include greater than or equal to 53 mol. % and less than or equal to 60 mol. % SiO₂. In embodiments, the glass composition may include greater than or equal to 54 mol. % and less than or equal to 59 mol. % SiO₂. In embodiments, the glass composition may include greater than or equal to 48 mol. % and less than or equal to 55 mol. % SiO₂. In embodiments, the glass composition may include greater than or equal to 49 mol. % and less than or equal to 54 mol. % SiO₂. In embodiments, the glass composition may include greater than or equal to 49 mol. % and less than or equal to 53 mol. % SiO₂. In embodiments, the glass composition may include greater than or equal to 49 mol. % and less than or equal to 52 mol. % SiO₂.

The glass compositions of Composition Space A may optionally include Al₂O₃. Al₂O₃ may act as both a network former and a modifier. Al₂O₃, when included, binds the alkali oxides in the glass network, increasing the viscosity of the glass. Al₂O₃ may also be added to the glass composition to reduce phase separation due to additions of B₂O₃ to the glass composition. However, additions of Al₂O₃ to the glass composition may also increase the softening point of the glass and lower the liquidus temperature, which may adversely impact the formability of the glass composition. Additionally, if the amount of Al₂O₃ in the glass composition is too high, the resistance of the glass composition to acid attack is diminished.

In embodiments, the glass compositions of Composition Space A may be substantially free of Al₂O₃. In other embodiments the glass compositions of Composition Space A may include Al₂O₃ in an amount greater than 0 mol. % and less than or equal to 1 mol. %. In these embodiments, the amount of Al₂O₃ in the glass composition may be greater than 0.1 mol. % to enhance the viscosity of the glass and reduce phase separation. The amount of Al₂O₃ may be less than or equal to 1 mol. % such that the resistance of the glass composition to acid attack is not diminished and the softening point and liquidus temperature are not adversely impacted. Accordingly, in the embodiments of the glass compositions of Composition Space A which contain Al₂O₃, the glass compositions generally comprise Al₂O₃ in an amount greater than or equal to 0.1 mol. % and less than or equal to 1 mol. %. In embodiments, the lower bound of the amount of Al₂O₃ in the glass composition may be greater than or equal to 0.1 mol. %, greater than or equal to 0.2 mol. %, greater than or equal to 0.3 mol. %, greater than or equal to 0.4 mol. %, or even greater than or equal to 0.5 mol. %. In embodiments, the upper bound of the amount of Al₂O₃ in the glass compositions may be less than or equal to 1.0 mol. %, less than or equal to 0.9 mol. %, less than or equal to 0.8 mol. %, or even less than or equal to 0.7 mol. %. It should be understood that the amount of Al₂O₃ in the glass compositions may be within a range formed from any one of the lower bounds for Al₂O₃ and any one of the upper bounds of Al₂O₃ described herein.

For example and without limitation, the glass compositions of Composition Space A may include Al₂O₃ in an amount greater than or equal to 0.1 mol. % and less than or equal to 1.0 mol. %. In embodiments, the amount of Al₂O₃ in the glass composition is greater than or equal to 0.1 mol. % and less than or equal to 0.9 mol. %. In embodiments, the amount of Al₂O₃ in the glass composition is greater than or equal to 0.1 mol. % and less than or equal to 0.8 mol. %. In embodiments, the amount of Al₂O₃ in the glass composition is greater than or equal to 0.1 mol. % and less than or equal to 0.7 mol. %. In embodiments, the amount of Al₂O₃ in the glass composition is greater than or equal to 0.2 mol. % and less than or equal to 1.0 mol. %. In embodiments, the amount of Al₂O₃ in the glass composition is greater than or equal to 0.3 mol. % and less than or equal to 1.0 mol. %. In embodiments, the amount of Al₂O₃ in the glass composition is greater than or equal to 0.4 mol. % and less than or equal to 1.0 mol. %.

Boron oxide (B₂O₃) is a glass former which may be added to the glass compositions of Composition Space A to reduce the viscosity of the glass at a given temperature thereby improving the formability of the glass. Said differently, additions of B₂O₃ to the glass decrease the strain, anneal, softening, and molding temperatures of the glass composition, thereby improving the formability of the glass. As such, additions of B₂O₃ may be used to offset the decrease in formability of glass compositions having relatively higher amounts of SiO₂. However, it has been found that if the amount of B₂O₃ in the glass composition is too high, the resistance of the glass composition to degradation in both acid and water may be diminished. Accordingly, in embodiments, the amount of B₂O₃ added to the glass composition is limited in order to preserve the chemical durability of the glass composition.

In embodiments, the glass compositions of Composition Space A include B₂O₃ in a concentration greater than or equal 7 mol. % to enhance the formability of the glass compositions. The concentration of B₂O₃ is less than or equal to 20 mol. % such that the resistance of the glass composition to degradation in acid and water is not diminished. Accordingly, in the embodiments, the glass compositions of Composition Space A generally comprise B₂O₃ in an amount greater than or equal to 7 mol. % and less than or equal to 20 mol. %. In embodiments, the lower bound of the amount of B₂O₃ in the glass composition may be greater than or equal to 7 mol. %, greater than or equal to 8 mol. %, greater than or equal to 9 mol. %, greater than or equal to 10 mol. %, greater than or equal to 11 mol. %, greater than or equal to 12 mol. %, greater than or equal to 13 mol. %, greater than or equal to 14 mol. %, or even greater than or equal to 15 mol. %. In embodiments, the upper bound of the amount of B₂O₃ in the glass compositions may be less than or equal to 20 mol. %, less than or equal to 19 mol. %, less than or equal to 18 mol. %, less than or equal to 17 mol. %, less than or equal to 16 mol. %, or even less than or equal to 15 mol. %. It should be understood that the amount of B₂O₃ in the glass compositions may be within a range formed from any one of the lower bounds for B₂O₃ and any one of the upper bounds of B₂O₃ described herein.

For example and without limitation, the glass compositions of Composition Space A may include B₂O₃ in an amount greater than or equal to 7 mol. % and less than or equal to 20 mol. %. In embodiments, the amount of B₂O₃ in the glass composition is greater than or equal to 10 mol. % and less than or equal to 20 mol. %. In embodiments, the amount of B₂O₃ in the glass composition is greater than or equal to 11 mol. % and less than or equal to 20 mol. %. In embodiments, the amount of B₂O₃ in the glass composition is greater than or equal to 12 mol. % and less than or equal to 20 mol. %. In embodiments, the amount of B₂O₃ in the glass composition is greater than or equal to 12 mol. % and less than or equal to 19 mol. %. In embodiments, the amount of B₂O₃ in the glass composition is greater than or equal to 12 mol. % and less than or equal to 19 mol. %. In embodiments, the amount of B₂O₃ in the glass composition is greater than or equal to 12 mol. % and less than or equal to 18 mol. %. In embodiments, the amount of B₂O₃ in the glass composition is greater than or equal to 12 mol. % and less than or equal to 17 mol. %. In embodiments, the amount of B₂O₃ in the glass composition is greater than or equal to 12 mol. % and less than or equal to 16 mol. %. In embodiments, the amount of B₂O₃ in the glass composition is greater than or equal to 12 mol. % and less than or equal to 15 mol. %. In embodiments, the amount of B₂O₃ in the glass composition is greater than or equal to 13 mol. % and less than or equal to 17 mol. %. In embodiments, the amount of B₂O₃ in the glass composition is greater than or equal to 14 mol. % and less than or equal to 17 mol. %.

The glass compositions of Composition Space A also include one or more alkali oxides. The sum of all alkali oxides (in mol. %) is expressed herein as R₂O. Specifically, R₂O is the sum of Na₂O (mol. %), K₂O (mol. %), and Li₂O (mol. %) present in the glass composition. Like B₂O₃, the alkali oxides aid in decreasing the softening point and molding temperature of the glass composition, thereby offsetting the increase in the softening point and molding temperature of the glass composition due to higher amounts of SiO₂ in the glass composition. The decrease in the softening point and molding temperature may be further enhanced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which can be undesirable.

In embodiments, the amount of alkali oxide (i.e., the amount of R₂O) in the glass compositions of Composition Space A may be greater than or equal to 9 mol. % and less than or equal to 16 mol. %. In embodiments, the lower bound of the amount of R₂O in the glass composition may be greater than or equal to 9 mol. %, greater than or equal to 9.5 mol. %, greater than or equal to 10 mol. %, greater than or equal to 10.5 mol. %, greater than or equal to 11 mol. %, greater than or equal to 11.5 mol. %, greater than or equal to 12 mol. %, greater than or equal to 12.5 mol. %, or even greater than or equal to 13 mol. %. In embodiments, the upper bound of the amount of R₂O in the glass composition may be less than or equal to 16.5 mol. %, less than or equal to 16 mol. %, less than or equal to 15.5 mol. %, less than or equal to 15 mol. %, less than or equal to 14.5 mol. %, or even less than or equal to 14 mol. %. It should be understood that the amount of R₂O in the glass compositions may be within a range formed from any one of the lower bounds for R₂O and any one of the upper bounds of R₂O described herein.

For example and without limitation, the glass compositions of Composition Space A may include R₂O in an amount greater than or equal to 9 mol. % and less than or equal to 16 mol. %. In embodiments, the amount of R₂O in the glass composition is greater than or equal to 9 mol. % and less than or equal to 15 mol. %. In embodiments, the amount of R₂O in the glass composition is greater than or equal to 9 mol. % and less than or equal to 14 mol. %. In embodiments, the amount of R₂O in the glass composition is greater than or equal to 9 mol. % and less than or equal to 13 mol. %. In embodiments, the amount of R₂O in the glass composition is greater than or equal to 10 mol. % and less than or equal to 16 mol. %. In embodiments, the amount of R₂O in the glass composition is greater than or equal to 10 mol. % and less than or equal to 15 mol. %. In embodiments, the amount of R₂O in the glass composition is greater than or equal to 10 mol. % and less than or equal to 14 mol. %. In embodiments, the amount of R₂O in the glass composition is greater than or equal to 10 mol. % and less than or equal to 13 mol. %. In embodiments, the amount of R₂O in the glass composition is greater than or equal to 11 mol. % and less than or equal to 16 mol. %. In embodiments, the amount of R₂O in the glass composition is greater than or equal to 11 mol. % and less than or equal to 15 mol. %. In embodiments, the amount of R₂O in the glass composition is greater than or equal to 11 mol. % and less than or equal to 14 mol. %. In embodiments, the amount of R₂O in the glass composition is greater than or equal to 11 mol. % and less than or equal to 13 mol. %.

It has been found that the alkali oxide Li₂O has a pronounced effect on reducing the melting point, softening point, and molding temperature of the glass compositions and, as such, Li₂O is effective at offsetting the reduction in formability of the glass composition due to higher concentrations of SiO₂ in the glass composition. However, as noted herein, lithium ions are highly mobile in the glass and, as such, are prone to migrating out of the glass. When the glass is coated, such as with a metallized layer or the like, or when the glass is in contact with liquids, lithium ions leaching from the glass may contaminate or degrade the coating and/or liquid. As such, in the embodiments described herein, the glass compositions are substantially free of Li₂O (i.e., R₂O is substantially free of Li₂O).

In the embodiments of the glass compositions of Composition Space A, the alkali oxide (R₂O) includes Na₂O. As noted herein, additions of alkali oxides such as Na₂O decrease the softening point and molding temperature of the glass composition, thereby offsetting the increase in the softening point and molding temperature of the glass composition due to higher amounts of SiO₂ in the glass composition. However, if the amount of Na₂O is too high, the coefficient of thermal expansion of the glass composition becomes too high, which is undesirable.

In embodiments of the glass compositions of Composition Space A that include Na₂O, the Na₂O may be present in the glass composition in an amount greater than or equal to 9 mol. % to improve the formability of the glass composition. The amount of Na₂O in the glass composition may be less than or equal to 15 mol. % so that the coefficient of thermal expansion is not undesirably high. Accordingly, the amount of Na₂O in the glass composition is greater than or equal to 9 mol. % and less than or equal to 15 mol. %. In embodiments, the lower bound of the amount of Na₂O in the glass composition may be greater than or equal to 9 mol. %, greater than or equal to 9.5 mol. %, greater than or equal to 10 mol. %, greater than or equal 10.5 mol. %, or even greater than or equal to 11 mol. %. In embodiments, the upper bound of the amount of Na₂O in the glass composition may be less than or equal to 15 mol. %, less than or equal to 14.5 mol. %, less than or equal to 14 mol. %, less than or equal to 13.5 mol. %, less than or equal to 13 mol. %, less than or equal to 12.5 mol. %, or even less than or equal to 12 mol. %. It should be understood that the amount of Na₂O in the glass compositions may be within a range formed from any one of the lower bounds for Na₂O and any one of the upper bounds of Na₂O described herein.

For example and without limitation, the glass compositions of Composition Space A may include Na₂O in an amount greater than or equal to 9 mol. % and less than or equal to 15 mol. %. In embodiments, the amount of Na₂O in the glass composition is greater than or equal to 9 mol. % and less than or equal to 14 mol. %. In embodiments, the amount of Na₂O in the glass composition is greater than or equal to 9 mol. % and less than or equal to 13 mol. %. In embodiments, the amount of Na₂O in the glass composition is greater than or equal to 9 mol. % and less than or equal to 12 mol. %. In embodiments, the amount of Na₂O in the glass composition is greater than or equal to 10 mol. % and less than or equal to 15 mol. %. In embodiments, the amount of Na₂O in the glass composition is greater than or equal to 10 mol. % and less than or equal to 14 mol. %. In embodiments, the amount of Na₂O in the glass composition is greater than or equal to 10 mol. % and less than or equal to 13 mol. %. In embodiments, the amount of Na₂O in the glass composition is greater than or equal to 10 mol. % and less than or equal to 12 mol. %.

The alkali oxide in the glass compositions of Composition Space A may optionally include K₂O. Like Na₂O, additions of K₂O decrease the softening point and molding temperature of the glass composition, thereby offsetting the increase in the softening point and molding temperature of the glass composition due to higher amounts of SiO₂ in the glass composition. However, if the amount of K₂O is too high, the coefficient of thermal expansion of the glass composition becomes too high, which is undesirable. Accordingly, it is desirable to limit the amount of K₂O present in the glass composition.

In embodiments, the glass compositions of Composition Space A may be substantially free of K₂O. In embodiments where the alkali oxide includes K₂O, the K₂O may be present in the glass composition in an amount greater than 0 mol. %, such as greater than or equal to 0.5 or even 1 mol. %, to aid in improving the formability of the glass composition. The amount of K₂O is less than or equal to 5 mol. % so that the coefficient of thermal expansion is not undesirably high. Accordingly, the amount of K₂O in the glass composition may be greater than or equal to 1 mol. %, and less than or equal to 5 mol. %. In embodiments, the lower bound of the amount of K₂O in the glass composition may be greater than or equal to 0.5 mol. %, greater than or equal to 1 mol. %, greater than or equal to 1.25 mol. %, greater than or equal to 1.5 mol. %, greater than or equal to 1.75 mol. %, greater than or equal to 2.0 mol. %, greater than or equal to 2.25 mol. %, greater than or equal to 2.5 mol. %, greater than or equal to 2.75 mol. %, or even greater than or equal to 3.0 mol. %. In embodiments, the upper bound of the amount of K₂O in the glass composition may be less than or equal to 5 mol. %, less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, or even less than or equal to 3 mol. %. It should be understood that the amount of K₂O in the glass compositions may be within a range formed from any one of the lower bounds for K₂O and any one of the upper bounds of K₂O described herein.

For example and without limitation, the glass compositions of Composition Space A may include K₂O in an amount greater than or equal to 1 mol. % to less than or equal to 5 mol. %. In embodiments, the amount of K₂O in the glass composition is greater than or equal to 1 mol. % and less than or equal to 4.75 mol. %. In embodiments, the amount of K₂O in the glass composition is greater than or equal to 1 mol. % and less than or equal to 4.5 mol. %. In embodiments, the amount of K₂O in the glass composition is greater than or equal to 1 mol. % and less than or equal to 4.25 mol. %. In embodiments, the amount of K₂O in the glass composition is greater than or equal to 1 mol. % and less than or equal to 4 mol. %. In embodiments, the amount of K₂O in the glass composition is greater than or equal to 1 mol. % and less than or equal to 3.75 mol. %. In embodiments, the amount of K₂O in the glass composition is greater than or equal to 1 mol. % and less than or equal to 3.5 mol. %. In embodiments, the amount of K₂O in the glass composition is greater than or equal to 1 mol. % and less than or equal to 3.25 mol. %. In embodiments, the amount of K₂O in the glass composition is greater than or equal to 1 mol. % and less than or equal to 3.0 mol. %.

The embodiments of the glass compositions of Composition Space A further include ZnO as the primary modifier of the glass composition. Additions of ZnO to the glass composition decrease the softening point and molding temperature of the glass composition, thereby offsetting the increase in the softening point and molding temperature of the glass composition due to higher amounts of SiO₂ in the glass composition. Significantly, additions of ZnO do not increase the average coefficient of thermal expansion of the glass composition over the temperature range from 20° C. to 300° C. as much as some other modifiers (e.g., alkali oxides and/or the alkaline earth oxides CaO, BaO, and SrO). As such, the benefit of using additions of ZnO to reduce the softening point and molding temperature can be maximized without a significant increase in the average coefficient of thermal expansion of the glass composition. In this regard, ZnO has a similar effect on the glass composition as MgO (e.g., it reduces the softening point and molding temperature of the glass composition without significantly increasing the average coefficient of thermal expansion). However, additions of ZnO to achieve these characteristics are favored over additions of MgO because ZnO has a more pronounced effect on the softening point and ZnO does not promote nucleation and crystallization in the glass as much as MgO.

In embodiments of the glass compositions of Composition Space A, the glass compositions include ZnO in an amount greater than or equal 8 mol. % to enhance the formability of the glass compositions. The amount of ZnO is less than or equal to 21 mol. % such that the liquidus viscosity of the glass composition is not diminished. Accordingly, in the embodiments described herein, the glass compositions generally comprise ZnO in an amount greater than or equal to 8 mol. % and less than or equal to 21 mol. %. In embodiments, the lower bound of the amount of ZnO in the glass composition may be greater than or equal to 8 mol. %, greater than or equal to 9 mol. %, greater than or equal to 10 mol. %, greater than or equal to 11 mol. %, greater than or equal to 12 mol. %, greater than or equal to 13 mol. %, greater than or equal to 14 mol. %, greater than or equal to 15 mol. %, greater than or equal to 16 mol. %, greater than or equal to 17 mol. %, greater than or equal to 18 mol. %, or even greater than or equal to 19 mol. %. In embodiments, the upper bound of the amount of ZnO in the glass compositions may be less than or equal to 21 mol. %, less than or equal to 20 mol. %, less than or equal to 19 mol. %, less than or equal to 18 mol. %, less than or equal to 17 mol. %, less than or equal to 16 mol. %, or even less than or equal to 15 mol. %. It should be understood that the amount of ZnO in the glass compositions may be within a range formed from any one of the lower bounds for ZnO and any one of the upper bounds of ZnO described herein.

For example and without limitation, the glass compositions of Composition Space A may include ZnO in an amount greater than or equal to 7 mol. % and less than or equal to 21 mol. %. In embodiments, the amount of ZnO in the glass composition is greater than or equal to 13 mol. % and less than or equal to 20 mol. %. In embodiments, the amount of ZnO in the glass composition is greater than or equal to 13 mol. % and less than or equal to 20 mol. %. In embodiments, the amount of ZnO in the glass composition is greater than or equal to 14 mol. % and less than or equal to 20 mol. %. In embodiments, the amount of ZnO in the glass composition is greater than or equal to 15 mol. % and less than or equal to 20 mol. %. In embodiments, the amount of ZnO in the glass composition is greater than or equal to 8 mol. % and less than or equal to 19 mol. %. In embodiments, the amount of ZnO in the glass composition is greater than or equal to 8 mol. % and less than or equal to 18 mol. %. In embodiments, the amount of ZnO in the glass composition is greater than or equal to 8 mol. % and less than or equal to 17 mol. %. In embodiments, the amount of ZnO in the glass composition is greater than or equal to 8 mol. % and less than or equal to 16 mol. %. In embodiments, the amount of ZnO in the glass composition is greater than or equal to 8 mol. % and less than or equal to 15 mol. %. In embodiments, the amount of ZnO in the glass composition is greater than or equal to 9 mol. % and less than or equal to 19 mol. %. In embodiments, the amount of ZnO in the glass composition is greater than or equal to 9 mol. % and less than or equal to 18 mol. %. In embodiments, the amount of ZnO in the glass composition is greater than or equal to 9 mol. % and less than or equal to 17 mol. %. In embodiments, the amount of ZnO in the glass composition is greater than or equal to 9 mol. % and less than or equal to 16 mol. %. In embodiments, the amount of ZnO in the glass composition is greater than or equal to 9 mol. % and less than or equal to 15 mol. %.

In embodiments of the glass compositions of Composition Space A described herein, a ratio of the amount of ZnO in the glass composition to the total amount of alkali oxides (i.e., ZnO (mol. %):R₂O (mol. %)) is greater than or equal to 0.75 and less than or equal to 2.0 to maintain a low liquidus temperature, softening point, and CTE. Glass compositions with a ratio of ZnO to RO within this range generally have a relatively low softening temperature and a relatively low average coefficient of thermal expansion over the temperature range from 20° C. to 300° C. In embodiments, the ratio ZnO (mol. %):R₂O (mol. %) is greater than or equal to 1.0 and less than or equal to 2.0. When the ratio exceeds 2, the liquidus temperature can increase which decreases the liquidus viscosity and glass stability so that it may be no longer suitable for downdrawing or fusion forming processes.

The glass compositions of Composition Space A also include one or more alkaline earth oxides. The sum of all alkaline earth oxides (in mol. %) is expressed herein as RO. Specifically, RO is the sum of MgO (mol. %), CaO (mol. %), BaO (mol. %), and SrO (mol. %) present in the glass composition. The alkaline earth oxides may be introduced in the glass to enhance various properties. For example, the addition of certain alkaline earth oxides may aid in decreasing the softening point and molding temperature of the glass composition, thereby offsetting the increase in the softening point and molding temperature of the glass composition due to higher amounts of SiO₂ in the glass composition. Additions of certain alkaline earth oxides may also aid in reducing the tendency of the glass to crystalize. In general, additions of alkaline earth oxide do not increase the average coefficient of thermal expansion of the glass composition over the temperature range from 20° C. to 300° C. as much as some other modifiers (e.g., alkali oxides). In addition, it has been found that relatively smaller alkaline earth oxides do not increase the average coefficient of thermal expansion of the glass composition over the temperature range from 20° C. to 300° C. as much as larger alkaline earth oxides. For example, MgO increases the average coefficient of thermal expansion of the glass composition less than BaO increases the average coefficient of thermal expansion of the glass composition.

In embodiments of the glass compositions of Composition Space A, the amount of alkaline earth oxide (i.e., the amount of RO) in the glass composition is less than one-half the amount of ZnO in the glass composition (i.e., RO (mol. %)<0.5×ZnO (mol. %)) such that the glass compositions are rich in ZnO relative to alkaline earth oxide to maintain a low molding temperature and CTE.

In embodiments, the glass compositions of Composition Space A may be substantially free of alkaline earth oxides. In embodiments of the glass compositions of Composition Space A which include alkaline earth oxides, the alkaline earth oxides may be present in an amount greater than 0 mol. %, such as greater than or equal to 0.5 mol. %, and less than or equal to 10 mol. %. In embodiments, the lower bound of the amount of alkaline earth oxide in the glass compositions may be greater than or equal to 0.5 mol. %, greater than or equal to 0.75 mol. %, greater or equal to 1.0 mol. %, greater than or equal to 1.5 mol. %, greater than or equal to 1.75 mol. %, greater or equal to 2.0 mol. %, greater or equal to 2.25 mol. %, greater than or equal to 2.5 mol. %, greater than or equal to 2.75 mol. %, greater or equal to 3.0 mol. %, greater or equal to 3.25 mol. %, greater than or equal to 3.5 mol. %, greater or equal to 3.75 mol. %, or even greater than or equal to 4.0 mol. %. In embodiments, the upper bound of the amount of alkaline earth oxide in the glass composition may be less than or equal to 10.0 mol. %, less than or equal to 9.5 mol. %, less than or equal to 9.0 mol. %, less than or equal to 8.5 mol. %, less than or equal to 8.0 mol. %, less than or equal to 7.5 mol. %, or even less than or equal to 7.0 mol. %, less than or equal to 6.5 mol. %, less than or equal to 6.0 mol. %, less than or equal to 5.5 mol. %, less than or equal to 5.0 mol. %, less than or equal to 4.5 mol. %, or even less than or equal to 4.0 mol. %. It should be understood that the amount of alkaline earth oxide in the glass compositions may be within a range formed from any one of the lower bounds for alkaline earth oxide and any one of the upper bounds of alkaline earth oxide described herein.

For example and without limitation, the glass compositions of Composition Space A may include alkaline earth oxide in an amount greater than or equal to 0.5 mol. % and less than or equal to 10.0 mol. %. In embodiments, the glass composition may include greater than or equal to 0.5 mol. % and less than or equal to 9.0 mol. % alkaline earth oxide. In embodiments, the glass composition may include greater than or equal to 0.5 mol. % and less than or equal to 8.0 mol. % alkaline earth oxide. In embodiments, the glass composition may include greater than or equal to 0.5 mol. % and less than or equal to 7.0 mol. % alkaline earth oxide. In embodiments, the glass composition may include greater than or equal to 0.5 mol. % and less than or equal to 6.0 mol. % alkaline earth oxide. In embodiments, the glass composition may include greater than or equal to 0.5 mol. % and less than or equal to 5.0 mol. % alkaline earth oxide. In embodiments, the glass composition may include greater than or equal to 0.75 mol. % and less than or equal to 5.0 mol. % alkaline earth oxide. In embodiments, the glass composition may include greater than or equal to 1.0 mol. % and less than or equal to 5.0 mol. % alkaline earth oxide. In embodiments, the glass composition may include greater than or equal to 1.5 mol. % and less than or equal to 5.0 mol. % alkaline earth oxide. In embodiments, the glass composition may include greater than or equal to 1.75 mol. % and less than or equal to 5.0 mol. % alkaline earth oxide. In embodiments, the glass composition may include greater than or equal to 2.0 mol. % and less than or equal to 5.0 mol. % alkaline earth oxide. In embodiments, the glass composition may include greater than or equal to 2.5 mol. % and less than or equal to 5.0 mol. % alkaline earth oxide.

In embodiments of the glass compositions of Composition Space A described herein, the alkaline earth oxide in the glass composition may optionally include MgO. In addition to improving the formability and the meltability of the glass composition, MgO may also increase the viscosity of the glass and reduce the tendency of the glass to crystalize. Too much MgO tends to cause crystallization in the glass, increasing the liquidus viscosity and decreasing formability.

In embodiments, the glass compositions of Composition Space A may be substantially free of MgO. In embodiments where the glass composition includes MgO, the amount of MgO may be greater than 0 mol. %, such as greater than or equal to 0.5 mol. %, and less than or equal to 5 mol. %. In embodiments, the lower bound of the amount of MgO in the glass composition may be greater than 0 mol. %, greater than or equal to 0.5 mol. %, greater or equal to 0.75 mol. %, greater than or equal to 1.0 mol. %, greater than or equal to 1.25 mol. %, greater than or equal to 1.5 mol. %, greater than or equal to 1.75 mol. %, or even greater than or equal to 2 mol. %. In embodiments, the upper bound of the amount of MgO in the glass composition may be less than or equal to 2.5 mol. %, less than or equal to 2.25 mol. %, or even less than or equal to 2.0 mol. %. It should be understood that the amount of MgO in the glass compositions may be within a range formed from any one of the lower bounds for MgO and any one of the upper bounds of MgO described herein.

For example and without limitation, the glass compositions of Composition Space A described may include MgO in an amount greater than or equal to 0.5 mol. % and less than or equal to 5 mol. %. In embodiments, the glass composition may include greater than or equal to 0.5 mol. % and less than or equal to 4.5 mol. % MgO. In embodiments, the glass composition may include greater than or equal to 0.5 mol. % and less than or equal to 4.0 mol. % MgO. In embodiments, the glass composition may include greater than or equal to 0.5 mol. % and less than or equal to 3.5 mol. % MgO. In embodiments, the glass composition may include greater than or equal to 0.5 mol. % and less than or equal to 3.0 mol. % MgO. In embodiments, the glass composition may include greater than or equal to 0.5 mol. % and less than or equal to 2.5 mol. % MgO.

In the embodiments described herein, the alkaline earth oxide in the glass compositions of Composition Space A may optionally include SrO. In addition to improving the formability and the meltability of the glass composition, SrO may also reduce the tendency of the glass to crystalize. Too much SrO changes the liquidus viscosity and may increase the CTE of the glass.

In embodiments, the glass compositions of Composition Space A may be substantially free of SrO. In embodiments where the glass composition includes SrO, the amount of SrO may be greater than 0 mol. %, such as greater than or equal to 0.5 mol. %, and less than or equal to 5 mol. %. In embodiments, the lower bound of the amount of SrO in the glass composition may be greater than 0 mol. %, greater than or equal to 0.5 mol. %, greater or equal to 0.75 mol. %, greater than or equal to 1.0 mol. %, greater than or equal to 1.25 mol. %, greater than or equal to 1.5 mol. %, greater than or equal to 1.75 mol. %, or even greater than or equal to 2 mol. %. In embodiments, the upper bound of the amount of SrO in the glass composition may be less than or equal to 2.5 mol. %, less than or equal to 2.25 mol. %, or even less than or equal to 2.0 mol. %. It should be understood that the amount of SrO in the glass compositions may be within a range formed from any one of the lower bounds for SrO and any one of the upper bounds of SrO described herein.

For example and without limitation, the glass compositions of Composition Space A may include SrO in an amount greater than or equal to 0.5 mol. % and less than or equal to 5 mol. %. In embodiments, the glass composition may include greater than or equal to 0.5 mol. % and less than or equal to 4.5 mol. % SrO. In embodiments, the glass may include greater than or equal to 0.5 mol. % and less than or equal to 4.0 mol. % SrO. In embodiments, the glass composition may include greater than or equal to 0.5 mol. % and less than or equal to 3.5 mol. % SrO. In embodiments, the glass composition may include greater than or equal to 0.5 mol. % and less than or equal to 3.0 mol. % SrO. In embodiments, the glass composition may include greater than or equal to 0.5 mol. % and less than or equal to 2.5 mol. % SrO.

In embodiments, the total amount of SrO and MgO in the glass compositions of Composition Space A (i.e., SrO (mol. %)+MgO (mol. %)) is greater than or equal to 0.5 mol. % and less than or equal to 10 mol. %. In embodiments, the total amount of SrO and MgO in the glass composition is greater than or equal to 0.5 mol. % and less than or equal to 9 mol. %. In embodiments, the total amount of SrO and MgO in the glass composition is greater than or equal to 0.5 mol. % and less than or equal to 8 mol. %. In embodiments, the total amount of SrO and MgO in the glass composition is greater than or equal to 0.5 mol. % and less than or equal to 7 mol. %. In embodiments, the total amount of SrO and MgO in the glass composition is greater than or equal to 0.5 mol. % and less than or equal to 6 mol. %. In embodiments, the total amount of SrO and MgO in the glass composition is greater than or equal to 0.5 mol. % and less than or equal to 5 mol. %. In embodiments, the total amount of SrO and MgO in the glass composition is greater than or equal to 0.5 mol. % and less than or equal to 4 mol. %. In embodiments, the total amount of SrO and MgO in the glass composition is greater than or equal to 0.5 mol. % and less than or equal to 3 mol. %. In embodiments, the total amount of SrO and MgO in the glass composition is greater than or equal to 0.5 mol. % and less than or equal to 2 mol. %.

In the embodiments of the glass compositions of Composition Space A described herein, the alkaline earth oxide in the glass composition may optionally include BaO. In addition to improving the formability and the meltability of the glass composition, small additions of BaO may also aid in reducing the liquidus temperature. Concentrations of BaO that are too high tend to undesirably increase the CTE and the density of the glass. Increases in the density negatively impact formability.

In embodiments, the glass compositions of Composition Space A may be substantially free of BaO. In embodiments where the glass composition includes BaO, the amount of BaO may be greater than 0 mol. %, such as greater than or equal to 0.5 mol. %, and less than or equal to 5 mol. %. In embodiments, the lower bound of the amount of BaO in the glass composition may be greater than 0 mol. %, greater than or equal to 0.5 mol. %, greater or equal to 0.75 mol. %, greater than or equal to 1.0 mol. %, greater than or equal to 1.25 mol. %, greater than or equal to 1.5 mol. %, greater than or equal to 1.75 mol. %, or even greater than or equal to 2 mol. %. In embodiments, the upper bound of the amount of BaO in the glass composition may be less than or equal to 2.5 mol. %, less than or equal to 2.25 mol. %, or even less than or equal to 2.0 mol. %. It should be understood that the amount of BaO in the glass compositions may be within a range formed from any one of the lower bounds for BaO and any one of the upper bounds of BaO described herein.

For example and without limitation, the glass compositions of Composition Space A may include BaO in an amount greater than or equal to 0.5 mol. % and less than or equal to 5 mol. %. In embodiments, the glass composition may include greater than or equal to 0.5 mol. % and less than or equal to 4.5 mol. % BaO. In embodiments, the glass composition may include greater than or equal to 0.5 mol. % and less than or equal to 4.0 mol. % BaO. In embodiments, the glass composition may include greater than or equal to 0.5 mol. % and less than or equal to 3.5 mol. % BaO. In embodiments, the glass composition may include greater than or equal to 0.5 mol. % and less than or equal to 3.0 mol. % BaO. In embodiments, the glass composition may include greater than or equal to 0.5 mol. % and less than or equal to 2.5 mol. % BaO.

In the embodiments of the glass compositions of Composition Space A described herein, the alkaline earth oxide in the glass composition may optionally include CaO. In addition to improving the formability and the meltability of the glass composition, CaO may also lower the liquidus temperature in small amounts while improving chemical durability and lowering the CTE. If the CaO content is too high (or if the MgO+CaO content is too high) then diopside crystals can form and degrade the liquidus viscosity.

In embodiments, the glass compositions of Composition Space A may be substantially free of CaO. In embodiments where the glass composition includes CaO, the amount of CaO may be greater than 0 mol. %, such as greater than or equal to 0.5 mol. %, and less than or equal to 5 mol. %. In embodiments, the lower bound of the amount of CaO in the glass composition may be greater than 0 mol. %, greater than or equal to 0.5 mol. %, greater or equal to 0.75 mol. %, greater than or equal to 1.0 mol. %, greater than or equal to 1.25 mol. %, greater than or equal to 1.5 mol. %, greater than or equal to 1.75 mol. %, or even greater than or equal to 2 mol. %. In embodiments, the upper bound of the amount of CaO in the glass composition may be less than or equal to 2.5 mol. %, less than or equal to 2.25 mol. %, or even less than or equal to 2.0 mol. %. It should be understood that the amount of CaO in the glass compositions may be within a range formed from any one of the lower bounds for CaO and any one of the upper bounds of CaO described herein.

For example and without limitation, the glass compositions of Composition Space A may include CaO in an amount greater than or equal to 0.5 mol. % and less than or equal to 5 mol. %. In embodiments, the glass composition may include greater than or equal to 0.5 mol. % and less than or equal to 4.5 mol. % CaO. In embodiments, the glass composition may include greater than or equal to 0.5 mol. % and less than or equal to 4.0 mol. % CaO. In embodiments, the glass composition may include greater than or equal to 0.5 mol. % and less than or equal to 3.5 mol. % CaO. In embodiments, the glass composition may include greater than or equal to 0.5 mol. % and less than or equal to 3.0 mol. % CaO. In embodiments, the glass composition may include greater than or equal to 0.5 mol. % and less than or equal to 2.5 mol. % CaO.

The glass compositions of Composition Space A may further comprise one or more additional metal oxides to further improve the chemical durability of the glass composition. Specifically, it has been found that additions of at least one of TiO₂ and ZrO₂ may further increase the chemical durability of the glass composition resulting in glass compositions which have good chemical durability, particularly with respect to the chemical durability of the glass in basic solutions. It has also been found that additions of at least one of TiO₂ and ZrO₂ beneficially decrease the average coefficient of thermal expansion of the glass composition.

Without wishing to be bound by theory, it is believed that the addition of at least one of TiO₂ and ZrO₂ improves the properties of the glass by enhancing the functionality of Al₂O₃ in the glass composition. With respect to chemical durability, it is believed that additions of Al₂O₃ to the glass composition reduce the amount of non-bridging oxygen in the glass composition which, in turn, improves the chemical durability of the glass. However, it has been found that if the amount of Al₂O₃ in the glass composition is too high, the resistance of the glass composition to acid attack is diminished. It has now been found that including at least one of TiO₂ and ZrO₂ in addition to Al₂O₃, further reduces the amount of non-bridging oxygen in the glass composition which, in turn, further improves the chemical durability of the glass beyond that achievable by additions of Al₂O₃ alone.

In embodiments, the glass compositions of Composition Space A may optionally include TiO₂. It has been found that additions of TiO₂ to the glass composition improve the hydrolytic resistance of the glass composition. In embodiments of the glass composition which include TiO₂, the lower bound of the amount of TiO₂ present in the glass composition may be greater than or equal to 0.1 mol. %, greater than or equal to 0.2 mol. %, greater than or equal to 0.3 mol. %, greater than or equal to 0.4 mol. %, greater than or equal to 0.5 mol. %, greater than or equal to 0.6 mol. %, greater than or equal to 0.7 mol. %, greater than or equal to 0.8 mol. %, greater than or equal to 0.9 mol. %, greater or equal to 1.0 mol. %, or even greater than or equal to 1.25 mol. %. In embodiments, the upper bound of the amount of TiO₂ in the glass composition may be less than or equal to 1.5 mol. %, less than or equal to 1.25 mol. %, or even less than or equal to 1.0 mol. %. It should be understood that the amount of TiO₂ in the glass compositions may be within a range formed from any one of the lower bounds for TiO₂ and any one of the upper bounds of TiO₂ described herein.

For example and without limitation, the glass compositions of Composition Space A may include TiO₂ in an amount greater than or equal to 0.1 mol. % and less than or equal to 1.5 mol. %. In embodiments, the glass composition may include greater than or equal to 0.1 mol. % and less than or equal to 1.0 mol. % TiO₂. In embodiments, the glass composition may include greater than or equal to 0.1 mol. % and less than or equal to 0.75 mol. % TiO₂. In embodiments, the glass composition may include greater than or equal to 0.1 mol. % and less than or equal to 0.5 mol. % TiO₂. In embodiments, the glass composition may include greater than or equal to 0.25 mol. % and less than or equal to 1.5 mol. % TiO₂. In embodiments, the glass composition may include greater than or equal to 0.5 mol. % and less than or equal to 1.5 mol. % TiO₂. In embodiments, the glass composition may include greater than or equal to 0.75 mol. % and less than or equal to 1.5 mol. % TiO₂. In embodiments, the glass composition may include greater than or equal to 1.0 mol. % and less than or equal to 1.5 mol. % TiO₂. In embodiments, the glass composition may include greater than or equal to 1.0 mol. % and less than or equal to 1.25 mol. % TiO₂.

Additions of ZrO₂ to the glass compositions of Composition Space A improve the base resistance of the glass composition. In embodiments of the glass composition which include ZrO₂, the lower bound of the amount of ZrO₂ present in the glass composition may be greater than or equal to 0.1 mol. %, greater than or equal to 0.2 mol. %, greater than or equal to 0.3 mol. %, greater than or equal to 0.4 mol. %, greater than or equal to 0.5 mol. %, greater than or equal to 0.6 mol. %, greater than or equal to 0.7 mol. %, greater than or equal to 0.8 mol. %, greater than or equal to 0.9 mol. %, greater or equal to 1.0 mol. %, or even greater than or equal to 1.25 mol. %. In embodiments, the upper bound of the amount of ZrO₂ in the glass composition may be less than or equal to 1.5 mol. %, less than or equal to 1.25 mol. %, or even less than or equal to 1.0 mol. %. It should be understood that the amount of ZrO₂ in the glass compositions may be within a range formed from any one of the lower bounds for ZrO₂ and any one of the upper bounds of ZrO₂ described herein.

For example and without limitation, the glass compositions of Composition Space A may include ZrO₂ in an amount greater than or equal to 0.1 mol. % and less than or equal to 1.5 mol. %. In embodiments, the glass composition may include greater than or equal to 0.1 mol. % and less than or equal to 1.0 mol. % ZrO₂. In embodiments, the glass composition may include greater than or equal to 0.1 mol. % and less than or equal to 0.75 mol. % ZrO₂. In embodiments, the glass composition may include greater than or equal to 0.1 mol. % and less than or equal to 0.5 mol. % ZrO₂. In embodiments, the glass composition may include greater than or equal to 0.25 mol. % and less than or equal to 1.5 mol. % ZrO₂. In embodiments, the glass composition may include greater than or equal to 0.5 mol. % and less than or equal to 1.5 mol. % ZrO₂. In embodiments, the glass composition may include greater than or equal to 0.75 mol. % and less than or equal to 1.5 mol. % ZrO₂. In embodiments, the glass composition may include greater than or equal to 1.0 mol. % and less than or equal to 1.5 mol. % ZrO₂. In embodiments, the glass composition may include greater than or equal to 1.0 mol. % and less than or equal to 1.25 mol. % ZrO₂.

Further, as noted hereinabove, the glass compositions of Composition Space A are chemically durable and resistant to degradation in acidic solutions, basic solutions, and water as determined by the acid test and the base test described herein, as well as the ISO 720 standard. The chemical durability of the glass compositions makes the glass compositions particularly well suited for use in applications in which the glass is contacted by liquids including, without limitation, acidic liquids, basic liquid, and water-based liquids.

The ISO 720 standard is a measure of the resistance of the glass to degradation in purified, CO₂-free water. In brief, the ISO 720 standard protocol utilizes crushed glass grains which are placed in contact with the purified, CO₂-free water at 121° C. and a pressure of 2 atmospheres. The solution is then titrated colorimetrically with dilute HCl to neutral pH. The amount of HCl required to titrate to a neutral solution is then converted to an equivalent of Na₂O extracted from the glass and reported in μg Na₂O per weight of glass with smaller values indicative of greater durability. The ISO 720 standard is divided into individual types. Type HGA1 is indicative of up to 62 μg extracted equivalent of Na₂O per gram of glass tested; Type HGA2 is indicative of more than 62 μg and up to 527 μg extracted equivalent of Na₂O per gram of glass tested; and Type HGA3 is indicative of more than 527 μg and up to 930 μg extracted equivalent of Na₂O per gram of glass tested.

As noted herein, the resistance of the glass to degradation in acid was measured by submerging a 2.54 cm×5.08 in.×1 mm thick sample of the glass composition in a solution of 5 wt. % HCl in water at 95° C. for 24 hours (hereinafter the “acid test”). The weight of the sample was measured before submersion and after submersion and the weight loss was determined per unit area (i.e., (initial weight−final weight)/total surface area (cm²)).

As noted herein, the resistance of the glass to degradation in a basic solution was measured by submerging a 2.54 cm×5.08 in.×1 mm thick sample of the glass composition in a solution of 5 wt. % NaOH in water at 95° C. for 6 hours (hereinafter the “base test”). The weight of the sample was measured before submersion and after submersion and the weight loss was determined per unit area (i.e., (initial weight−final weight)/total surface area (cm²)).

The glass compositions of Composition Space A have an ISO 720 type HGA2 or a type HGA1 hydrolytic resistance. In embodiments, the glass compositions described herein have an ISO 720 type HGA1 hydrolytic resistance. In some embodiments, the glass compositions of Composition Space A may have a weight loss of less than 10 mg/cm², less than or equal to 1 mg/cm², or even less than or equal to 0.1 mg/cm² following exposure to the acid test. In some embodiments, the glass compositions of Composition Space A may have a weight loss of less than 10 mg/cm², less than or equal to 5 mg/cm², or even less than or equal to 2 mg/cm² following exposure to the base test.

In the embodiments of the glass compositions of Composition Space A described herein, the glass compositions have an average coefficient of thermal expansion (CTE) of greater than or equal to 75×10⁻⁷/° C. and less than or equal to 88×10⁻⁷/° C. over the temperature range from 20° C. to 300° C. For example, in embodiments, the glass compositions have an average coefficient of thermal expansion (CTE) of greater than or equal to 77×10⁻⁷/° C. and less than or equal to 88×10⁻⁷/° C. over the temperature range from 20° C. to 300° C. In embodiments, the glass compositions have an average coefficient of thermal expansion (CTE) of greater than or equal to 78×10⁻⁷/° C. and less than or equal to 88×10⁻⁷/° C. over the temperature range from 20° C. to 300° C. In embodiments, the glass compositions have an average coefficient of thermal expansion (CTE) of greater than or equal to 79×10⁻⁷/° C. and less than or equal to 88×10⁻⁷/° C. over the temperature range from 20° C. to 300° C. In embodiments, the glass compositions have an average coefficient of thermal expansion (CTE) of greater than or equal to 80×10⁻⁷/° C. and less than or equal to 88×10⁻⁷/° C. over the temperature range from 20° C. to 300° C. These relatively low CTE values improve the survivability of the glass to thermal cycling or thermal stress conditions compared to glass compositions with relatively higher CTEs.

As noted herein, the glass compositions have softening points and molding temperatures which are relatively low. This improves the ease of remolding the glass compositions from stock materials to final form. These relatively low temperatures may also extend the service life of the molds which contact the glass as the lower molding temperatures reduce the oxidation of metal parts of the mold and minimize chemical reactions between the mold and the glass composition.

In the embodiments of the glass compositions of Composition Space A described herein, the glass compositions have softening points of less than or equal to 660° C. In embodiments, the glass compositions have softening points of less than or equal to 650° C. or even less than or equal to 640° C.

In the embodiments of the glass compositions of Composition Space A described herein, the glass compositions have molding temperatures of less than or equal to 630° C. In embodiments, the glass compositions have molding temperatures of less than or equal to 620° C., less than or equal to 610° C., less than or equal to 600° C., or even less than or equal to 590° C.

The glass compositions of Composition Space A may generally have strain points greater than or equal to about 400° C. and less than or equal to about 550° C. or even greater than or equal to about 400° C. and less than or equal to about 500° C. The glass compositions may also have anneal points greater than or equal to about 450° C. and less than or equal to about 600° C. or even greater than or equal to about 500° C. and less than or equal to about 550° C.

In some embodiments, the glass compositions of Composition Space A may have liquidus viscosities greater than or equal to 90 kilopoise (kP) such that the glasses are compatible with sheet-forming processes (i.e., fusion drawing processes, slot draw processes, and the like). In some other embodiments, the glass compositions of Composition Space A may have liquidus viscosities less than 90 kilopoise (kP).

Composition Space B: Lithium-Free, Low ZnO Glass Compositions with Fluorine

The glass compositions in Composition Space B include a combination of SiO₂, Al₂O₃, alkali oxides (R₂O), and F₂ which provides the glass compositions with relatively low coefficients of thermal expansion (e.g., less than or equal to 92×10⁻⁷/° C. over a temperature range from about 20° C. to about 300° C.), softening points less than or equal to 680° C., and hydrolytic resistances of class HGA1 or class HGA2 according to ISO 720:1985.

In the embodiments of the glass compositions of Composition Space B, SiO₂ is the largest constituent of the composition and, as such, is the primary constituent of the resulting glass network. That is, SiO₂ is the primary network former. SiO₂ enhances the chemical durability of the glass and, in particular, the resistance of the glass composition to decomposition in acid and the resistance of the glass composition to decomposition in water. Accordingly, a high SiO₂ concentration is generally desired. However, if the content of SiO₂ is too high, the formability of the glass may be diminished as higher concentrations of SiO₂ increase the difficulty of softening, molding, and melting the glass which, in turn, adversely impacts the formability of the glass. In embodiments of the glass compositions of Composition Space B, the properties of the glass composition due to the relatively high amount of SiO₂ may be offset by additions of other constituents, such as fluorine and the like, which improve the formability of the glass composition.

In embodiments, the glass compositions of Composition Space B may include SiO₂ in an amount greater than or equal 66 mol. % to provide a glass composition which is chemically durable. The amount of SiO₂ may be less than or equal to 74 mol. % such that, with the addition of other glass modifiers, the glass composition may be readily melted and formed. Accordingly, in embodiments described herein, the glass composition may comprise SiO₂ in an amount greater than or equal to 66 mol. % and less than or equal to 74 mol. %. In embodiments, the lower bound of the amount of SiO₂ in the glass composition may be greater than or equal to 66 mol. %, greater than or equal to 67 mol. %, greater than or equal to 68 mol. %, greater than or equal to 69 mol. %, greater than or equal to 70 mol. %, or even greater than or equal to 71 mol. %. In embodiments, the upper bound of the amount of SiO₂ in the glass composition may be less than or equal to 74 mol. %, less than or equal to 73 mol. %, less than or equal to 72 mol. %, or even less than or equal to 71 mol. %. It should be understood that the amount of SiO₂ in the glass compositions may be within a range formed from any one of the lower bounds for SiO₂ and any one of the upper bounds of SiO₂ described herein.

For example and without limitation, in embodiments, the glass compositions of Composition Space B may include greater than or equal to 66 mol. % and less than or equal to 74 mol. % SiO₂. In embodiments, the glass composition may include greater than or equal to 67 mol. % and less than or equal to 74 mol. % SiO₂. In embodiments, the glass composition may include greater than or equal to 68 mol. % and less than or equal to 74 mol. % SiO₂. In embodiments, the glass composition may include greater than or equal to 69 mol. % and less than or equal to 74 mol. % SiO₂. In embodiments, the glass composition may include greater than or equal to 70 mol. % and less than or equal to 74 mol. % SiO₂. In embodiments, the glass composition may include greater than or equal to 70 mol. % and less than or equal to 73 mol. % SiO₂. In embodiments, the glass composition may include greater than or equal to 70 mol. % and less than or equal to 72 mol. % SiO₂.

The glass compositions of Composition Space B also include Al₂O₃. Al₂O₃ may act as both a network former and a modifier. Al₂O₃ binds the alkali oxides in the glass network, increasing the viscosity of the glass. Al₂O₃ may also be added to the glass composition to reduce phase separation due to additions of B₂O₃ to the glass composition. However, additions of Al₂O₃ to the glass composition may also increase the softening point of the glass and lower the liquidus temperature, which may adversely impact the formability of the glass composition. Additionally, if the amount of Al₂O₃ in the glass composition is too high, the resistance of the glass composition to acid attack is diminished.

In embodiments, the glass composition may be substantially free of Al₂O₃. In other embodiments the glass composition may include Al₂O₃ in an amount greater than 3 mol. % and less than or equal to 7 mol. %. In these embodiments, the amount of Al₂O₃ in the glass composition may be greater than 3 mol. %. The amount of Al₂O₃ may be less than or equal to 7 mol. % such that the resistance of the glass composition to acid attack is not diminished. In embodiments, the lower bound of the amount of Al₂O₃ in the glass composition may be greater than or equal to 3 mol. %, greater than or equal to 3.5 mol. %, greater than or equal to 4.0 mol. %, greater than or equal to 4.5 mol. %, or even greater than or equal to 5.0 mol. %. In embodiments, the upper bound of the amount of Al₂O₃ in the glass compositions may be less than or equal to 7.0 mol. %, less than or equal to 6.75 mol. %, less than or equal to 6.5 mol. %, or even less than or equal to 6.25 mol. %. It should be understood that the amount of Al₂O₃ in the glass compositions may be within a range formed from any one of the lower bounds for Al₂O₃ and any one of the upper bounds of Al₂O₃ described herein.

For example and without limitation, the glass compositions of Composition Space B may include Al₂O₃ in an amount greater than or equal to 3 mol. % and less than or equal to 7.0 mol. %. In embodiments, the amount of Al₂O₃ in the glass composition is greater than or equal to 3.5 mol. % and less than or equal to 7.0 mol. %. In embodiments, the amount of Al₂O₃ in the glass composition is greater than or equal to 4.0 mol. % and less than or equal to 7.0 mol. %. In embodiments, the amount of Al₂O₃ in the glass composition is greater than or equal to 4.5 mol. % and less than or equal to 7.5 mol. %. In embodiments, the amount of Al₂O₃ in the glass composition is greater than or equal to 5.0 mol. % and less than or equal to 7.0 mol. %. In embodiments, the amount of Al₂O₃ in the glass composition is greater than or equal to 5.5 mol. % and less than or equal to 7.0 mol. %.

Boron oxide (B₂O₃) is a glass former which may be added to the glass compositions of Composition Space B to reduce the viscosity of the glass at a given temperature thereby improving the formability of the glass. Said differently, additions of B₂O₃ to the glass decrease the strain, anneal, softening, and molding temperatures of the glass composition, thereby improving the formability of the glass. As such, additions of B₂O₃ may be used to offset the decrease in formability of glass compositions having relatively higher amounts of SiO₂. However, it has been found that if the amount of B₂O₃ in the glass composition is too high, the resistance of the glass composition to degradation in both acid and water may be diminished. Accordingly, in embodiments, the amount of B₂O₃ added to the glass composition is limited in order to preserve the chemical durability of the glass composition.

In embodiments, the glass compositions of Composition Space B may be substantially free of B₂O₃. In embodiments, the glass compositions of Composition Space B may include greater than 0 mol. % B₂O₃, such as greater than or equal to 0.1 mol. % B₂O₃ to enhance the formability of the glass compositions. The concentration of B₂O₃ is less than or equal to 6 mol. % such that the resistance of the glass composition to degradation in acid and water is not diminished. In embodiments of the glass composition which include B₂O₃, the glass compositions generally comprise B₂O₃ in an amount greater than or equal to 0.1 mol. % and less than or equal to 6 mol. %. In embodiments, the lower bound of the amount of B₂O₃ in the glass composition may be greater than or equal to 0.1 mol. %, greater than or equal to 0.2 mol. %, greater than or equal to 0.3 mol. %, greater than or equal to 0.4 mol. %, greater than or equal to 0.5 mol. %, greater than or equal to 0.6 mol. %, greater than or equal to 0.7 mol. %, greater than or equal to 0.8 mol. %, greater than or equal to 0.9 mol. %, or even greater than or equal to 1.0 mol. %. In embodiments, the upper bound of the amount of B₂O₃ in the glass compositions may be less than or equal to 6 mol. %, less than or equal to 5.5 mol. %, less than or equal to 5.0 mol. %, less than or equal to 4.5 mol. %, less than or equal to 4.0 mol. %, less than or equal to 3.5 mol. %, or even less than or equal to 3.0 mol. %. It should be understood that the amount of B₂O₃ in the glass compositions may be within a range formed from any one of the lower bounds for B₂O₃ and any one of the upper bounds of B₂O₃ described herein.

For example and without limitation, the glass compositions of Composition Space B may include B₂O₃ in an amount greater than or equal to 0.1 mol. % and less than or equal to 6 mol. %. In embodiments, the amount of B₂O₃ in the glass composition is greater than or equal to 0.2 mol. % and less than or equal to 6.0 mol. %. In embodiments, the amount of B₂O₃ in the glass composition is greater than or equal to 0.3 mol. % and less than or equal to 6.0 mol. %. In embodiments, the amount of B₂O₃ in the glass composition is greater than or equal to 0.4 mol. % and less than or equal to 6.0 mol. %. In embodiments, the amount of B₂O₃ in the glass composition is greater than or equal to 0.3 mol. % and less than or equal to 5.5 mol. %. In embodiments, the amount of B₂O₃ in the glass composition is greater than or equal to 0.3 mol. % and less than or equal to 5.0 mol. %. In embodiments, the amount of B₂O₃ in the glass composition is greater than or equal to 0.3 mol. % and less than or equal to 4.5 mol. %. In embodiments, the amount of B₂O₃ in the glass composition is greater than or equal to 0.3 mol. % and less than or equal to 4.0 mol. %. In embodiments, the amount of B₂O₃ in the glass composition is greater than or equal to 0.3 mol. % and less than or equal to 3.5 mol. %. In embodiments, the amount of B₂O₃ in the glass composition is greater than or equal to 0.3 mol. % and less than or equal to 3.0 mol. %. In embodiments, the amount of B₂O₃ in the glass composition is greater than or equal to 0.3 mol. % and less than or equal to 2.5 mol. %. In embodiments, the amount of B₂O₃ in the glass composition is greater than or equal to 0.3 mol. % and less than or equal to 2.0 mol. %.

The glass compositions of Composition Space B also include one or more alkali oxides. The sum of all alkali oxides (in mol. %) is expressed herein as R₂O. Specifically, R₂O is the sum of Na₂O (mol. %), K₂O (mol. %), and Li₂O (mol. %) present in the glass composition. Like B₂O₃, the alkali oxides aid in decreasing the softening point and molding temperature of the glass composition, thereby offsetting the increase in the softening point and molding temperature of the glass composition due to higher amounts of SiO₂ in the glass composition. The decrease in the softening point and molding temperature may be further enhanced by including combinations of alkali oxides (e.g., two or more alkali oxides) in the glass composition, a phenomenon referred to as the “mixed alkali effect.” However, it has been found that if the amount of alkali oxides is too high, the average coefficient of thermal expansion of the glass composition increases to greater than 100×10⁻⁷/° C., which is undesirable.

In embodiments, the amount of alkali oxide (i.e., the amount of R₂O) in the glass composition may be greater than or equal to 11 mol. % and less than or equal to 23 mol. %. In embodiments, the lower bound of the amount of R₂O in the glass composition may be greater than or equal to 11 mol. %, greater than or equal to 11.5 mol. %, greater than or equal to 12 mol. %, greater than or equal to 12.5 mol. %, greater than or equal to 13 mol. %, greater than or equal to 13.5 mol. %, greater than or equal to 14 mol. %, or even greater than or equal to 14.5 mol. %. In embodiments, the upper bound of the amount of R₂O in the glass composition may be less than or equal to 23 mol. %, less than or equal to 23.5 mol. %, less than or equal to 22 mol. %, less than or equal to 21.5 mol. %, less than or equal to 21 mol. %, less than or equal to 20.5 mol. %, less than or equal to 20 mol. %, less than or equal to 19.5 mol. %, less than or equal to 19 mol. %, less than or equal to 18.5 mol. %, less than or equal to 18 mol. %, less than or equal to 17.5 mol. %, or even less than or equal to 17 mol. %. It should be understood that the amount of R₂O in the glass compositions may be within a range formed from any one of the lower bounds for R₂O and any one of the upper bounds of R₂O described herein.

For example and without limitation, the glass compositions of Composition Space B may include R₂O in an amount greater than or equal to 11 mol. % and less than or equal to 23 mol. %. In embodiments, the amount of R₂O in the glass composition is greater than or equal to 11 mol. % and less than or equal to 22 mol. %. In embodiments, the amount of R₂O in the glass composition is greater than or equal to 11 mol. % and less than or equal to 21 mol. %. In embodiments, the amount of R₂O in the glass composition is greater than or equal to 11 mol. % and less than or equal to 20 mol. %. In embodiments, the glass compositions may include R₂O in an amount greater than or equal to 11 mol. % and less than or equal to 19 mol. %. In embodiments, the amount of R₂O in the glass composition is greater than or equal to 11 mol. % and less than or equal to 18 mol. %. In embodiments, the amount of R₂O in the glass composition is greater than or equal to 11 mol. % and less than or equal to 17 mol. %. In embodiments, the amount of R₂O in the glass composition is greater than or equal to 12 mol. % and less than or equal to 20 mol. %. In embodiments, the glass compositions may include R₂O in an amount greater than or equal to 13 mol. % and less than or equal to 20 mol. %. In embodiments, the amount of R₂O in the glass composition is greater than or equal to 14 mol. % and less than or equal to 20 mol. %. In embodiments, the amount of R₂O in the glass composition is greater than or equal to 15 mol. % and less than or equal to 20 mol. %. In embodiments, the amount of R₂O in the glass composition is greater than or equal to 16 mol. % and less than or equal to 20 mol. %.

It has been found that the alkali oxide Li₂O has a pronounced effect on reducing the melting point, softening point, and molding temperature of the glass composition and, as such, is effective at offsetting the reduction in formability of the glass composition due to higher concentrations of SiO₂ in the glass composition. However, as noted herein, lithium ions are highly mobile in the glass and, as such, are prone to migrating out of the glass. When the glass is coated, such as with a metallized layer of the like, or when the glass is in contact with liquids, lithium ions leaching from the glass may contaminate or degrade the coating and/or liquid. As such, in the embodiments described herein, the glass composition are substantially free of Li₂O (i.e., R₂O is substantially free of Li₂O).

In the embodiments of the glass compositions of Composition Space B, the alkali oxide (R₂O) includes Na₂O. As noted herein, additions of alkali oxides such as Na₂O decrease the softening point and molding temperature of the glass composition, thereby offsetting the increase in the softening point and molding temperature of the glass composition due to higher amounts of SiO₂ in the glass composition. However, if the amount of Na₂O is too high, the coefficient of thermal expansion of the glass composition becomes too high, which is undesirable.

In embodiments where the alkali oxide includes Na₂O, the Na₂O may be present in the glass composition in an amount greater than or equal to 11 mol. % to improve the formability of the glass composition. The amount of Na₂O in the glass composition may be less than or equal to 18 mol. % so that the coefficient of thermal expansion is not undesirably high. Accordingly, the amount of Na₂O in the glass composition is greater than or equal to 11 mol. % and less than or equal to 18 mol. %. In embodiments, the lower bound of the amount of Na₂O in the glass composition may be greater than or equal to 11 mol. %, greater than or equal to 11.5 mol. %, greater than or equal to 12 mol. %, greater than or equal 12.5 mol. %, greater than or equal 13 mol. %, greater than or equal to 13.5 mol. %, greater than or equal to 14 mol. %, greater than or equal 14.5 mol. %, or even greater than or equal to 15 mol. %. In embodiments, the upper bound of the amount of Na₂O in the glass composition may be less than or equal to 18 mol. %, less than or equal to 17.5 mol. %, less than or equal to 17 mol. %, less than or equal to 16.5 mol. %, less than or equal to 16 mol. %, or even less than or equal to 15.5 mol. %. It should be understood that the amount of Na₂O in the glass compositions may be within a range formed from any one of the lower bounds for Na₂O and any one of the upper bounds of Na₂O described herein.

For example and without limitation, the glass compositions of Composition Space B may include Na₂O in an amount greater than or equal to 11 mol. % and less than or equal to 18 mol. %. In embodiments, the amount of Na₂O in the glass composition is greater than or equal to 12 mol. % and less than or equal to 18 mol. %. In embodiments, the amount of Na₂O in the glass composition is greater than or equal to 13 mol. % and less than or equal to 18 mol. %. In embodiments, the amount of Na₂O in the glass composition is greater than or equal to 14 mol. % and less than or equal to 18 mol. %. In embodiments, the amount of Na₂O in the glass composition is greater than or equal to 15 mol. % and less than or equal to 18 mol. %. In embodiments, the amount of Na₂O in the glass composition is greater than or equal to 12 mol. % and less than or equal to 17 mol. %. In embodiments, the amount of Na₂O in the glass composition is greater than or equal to 12 mol. % and less than or equal to 16 mol. %. In embodiments, the amount of Na₂O in the glass composition is greater than or equal to 13 mol. % and less than or equal to 16 mol. %.

The alkali oxide (R₂O) in the glass compositions of Composition Space B may optionally include K₂O. Like Na₂O, additions of K₂O decrease the softening point and molding temperature of the glass composition, thereby offsetting the increase in the softening point and molding temperature of the glass composition due to higher amounts of SiO₂ in the glass composition. However, if the amount of K₂O is too high, the coefficient of thermal expansion of the glass composition becomes too high, which is undesirable. Accordingly, it is desirable to limit the amount of K₂O present in the glass composition.

In embodiments, the glass compositions of Composition Space B may be substantially free of K₂O. In embodiments where the alkali oxide includes K₂O, the K₂O may be present in the glass composition in an amount greater than 0 mol. %, such as greater than or equal to 0.5 mol. %, to aid in improving the formability of the glass composition. The amount of K₂O is less than or equal to 4 mol. % so that the coefficient of thermal expansion is not undesirably high. Accordingly, the amount of K₂O in the glass composition may be greater than or equal to 0.5 mol. %, and less than or equal to 4 mol. %. In embodiments, the lower bound of the amount of K₂O in the glass composition may be greater than or equal to 0.5 mol. %, greater than or equal to 0.75 mol. %, or even greater than or equal to 1.0 mol. %. In embodiments, the upper bound of the amount of K₂O in the glass composition may be less than or equal to 4 mol. %, less than or equal to 3.75 mol. %, less than or equal to 3.5 mol. %, less than or equal to 3.25 mol. %, less than or equal to 3 mol. %, less than or equal to 2.75 mol. %, less than or equal to 2.5 mol. %, less than or equal to 2.25 mol. %, less than or equal to 2.0 mol. %, less than or equal to 1.75 mol. %, or even less than or equal to 1.5 mol. %. It should be understood that the amount of K₂O in the glass compositions may be within a range formed from any one of the lower bounds for K₂O and any one of the upper bounds of K₂O described herein.

For example and without limitation, the glass compositions of Composition Space B may include K₂O in an amount greater than or equal to 0.5 mol. % to less than or equal to 4 mol. %. In embodiments, the amount of K₂O in the glass composition is greater than or equal to 0.75 mol. % and less than or equal to 3.75 mol. %. In embodiments, the amount of K₂O in the glass composition is greater than or equal to 0.75 mol. % and less than or equal to 3.5 mol. %. In embodiments, the amount of K₂O in the glass composition is greater than or equal to 0.75 mol. % and less than or equal to 3.25 mol. %. In embodiments, the amount of K₂O in the glass composition is greater than or equal to 0.75 mol. % and less than or equal to 3.0 mol. %. In embodiments, the amount of K₂O in the glass composition is greater than or equal to 0.75 mol. % and less than or equal to 2.75 mol. %. In embodiments, the amount of K₂O in the glass composition is greater than or equal to 0.75 mol. % and less than or equal to 2.5 mol. %. In embodiments, the amount of K₂O in the glass composition is greater than or equal to 0.75 mol. % and less than or equal to 2.25 mol. %. In embodiments, the amount of K₂O in the glass composition is greater than or equal to 0.75 mol. % and less than or equal to 2.0 mol. %. In embodiments, the amount of K₂O in the glass composition is greater than or equal to 0.75 mol. % and less than or equal to 1.75 mol. %. In embodiments, the amount of K₂O in the glass composition is greater than or equal to 0.75 mol. % and less than or equal to 1.5 mol. %.

The glass compositions of Composition Space B also contain fluorine (F₂). Additions of fluorine to the glass compositions considerably decrease the softening points and molding temperatures of the glass compositions, allowing for the amount of SiO₂ in the glass to be increased, thereby improving the chemical durability of the glass compositions. As such, additions of F₂ may be used to offset the decrease in formability of glass compositions having relatively higher amounts of SiO₂.

In embodiments, the glass compositions of Composition Space B may include greater than 2.5 mol. % F₂, such as greater than or equal to 3.0 mol. % F₂, to enhance the formability of the glass compositions. The concentration of F₂ is less than or equal to 5 mol. %. If the concentration of F₂ is too high, the glass can become unstable and crystallize. Alkali and alkaline earth fluoride crystals may become problematic at F₂ concentrations above 5 mol. % and even lower when there is insufficient Al₂O₃ in the glass, especially upon reheating the glass above the anneal point. Accordingly, in the embodiments of the glass compositions of Composition Space B described herein, the glass compositions generally comprise F₂ in an amount greater than or equal to 2.5 mol. % and less than or equal to 5 mol. %. In embodiments, the lower bound of the amount of F₂ in the glass composition may be greater than or equal to 2.5 mol. %, greater than or equal to 2.75 mol. %, greater than or equal to 3.0 mol. %, or even greater than or equal to 3.25 mol. %. In embodiments, the upper bound of the amount of F₂ in the glass compositions may be less than or equal to 5 mol. %, less than or equal to 4.75 mol. %, less than or equal to 4.5 mol. %, less than or equal to 4.25 mol. %, less than or equal to 4.0 mol. %, less than or equal to 3.75 mol. %, or even less than or equal to 3.5 mol. %. It should be understood that the amount of F₂ in the glass compositions may be within a range formed from any one of the lower bounds for F₂ and any one of the upper bounds of F₂ described herein.

For example and without limitation, the glass compositions of Composition Space B may include F₂ in an amount greater than or equal to 2.5 mol. % and less than or equal to 5.0 mol. %. In embodiments, the amount of F₂ in the glass composition is greater than or equal to 2.75 mol. % and less than or equal to 5.0 mol. %. In embodiments, the amount of F₂ in the glass composition is greater than or equal to 3.0 mol. % and less than or equal to 5.0 mol. %. In embodiments, the amount of F₂ in the glass composition is greater than or equal to 3.25 mol. % and less than or equal to 5.0 mol. %. In embodiments, the amount of F₂ in the glass composition is greater than or equal to 3.5 mol. % and less than or equal to 5.0 mol. %. In embodiments, the amount of F₂ in the glass composition is greater than or equal to 3.75 mol. % and less than or equal to 5.0 mol. %. In embodiments, the amount of F₂ in the glass composition is greater than or equal to 3.0 mol. % and less than or equal to 4.5 mol. %. In embodiments, the amount of F₂ in the glass composition is greater than or equal to 3.0 mol. % and less than or equal to 4.25 mol. %. In embodiments, the amount of F₂ in the glass composition is greater than or equal to 3.0 mol. % and less than or equal to 4.0 mol. %. In embodiments, the amount of F₂ in the glass composition is greater than or equal to 3.0 mol. % and less than or equal to 3.75 mol. %.

The embodiments of the glass compositions of Composition Space B may optionally include ZnO. Additions of ZnO to the glass composition decrease the softening point and molding temperature of the glass composition, thereby offsetting the increase in the softening point and molding temperature of the glass composition due to higher amounts of SiO₂ in the glass composition. Significantly, additions of ZnO do not increase the average coefficient of thermal expansion of the glass composition over the temperature range from 20° C. to 300° C. as much as some other modifiers (e.g., alkali oxides and/or the alkaline earth oxides CaO, BaO, and SrO). As such, the benefit of using additions of ZnO to reduce the softening point and molding temperature can be maximized without a significant increase in the average coefficient of thermal expansion of the glass composition.

Embodiments of the glass compositions in Composition Space B may be substantially free of ZnO. Some embodiments of the glass compositions of Composition Space B may include greater than 0 mol. % ZnO, such as greater than or equal to 0.1 mol. % ZnO to enhance the formability of the glass compositions. The concentration of ZnO is less than or equal to 3.0 mol. % such that the liquidus viscosity of the glass composition is not diminished. Accordingly, in the embodiments where the glass compositions comprise ZnO, the glass compositions generally comprise ZnO in an amount greater than or equal to 0.1 mol. % and less than or equal to 3.0 mol. %. In embodiments, the lower bound of the amount of ZnO in the glass composition may be greater than or equal to 0.1 mol. %, greater than or equal to 0.2 mol. %, greater than or equal to 0.3 mol. %, greater than or equal to 0.4 mol. %, greater than or equal to 0.5 mol. %, greater than or equal to 0.6 mol. %, greater than or equal to 0.7 mol. %, greater than or equal to 0.8 mol. %, greater than or equal to 0.9 mol. %, or even greater than or equal to 1 mol. %. In embodiments, the upper bound of the amount of ZnO in the glass compositions may be less than or equal to 3.0 mol. %, less than or equal to 2.75 mol. %, less than or equal to 2.5 mol. %, less than or equal to 2.25 mol. %, or even less than or equal to 2.0 mol. %. It should be understood that the amount of ZnO in the glass compositions may be within a range formed from any one of the lower bounds for ZnO and any one of the upper bounds of ZnO described herein.

For example and without limitation, the glass compositions of Composition Space B may include ZnO in an amount greater than or equal to 0.5 mol. % and less than or equal to 3.0 mol. %. In embodiments, the amount of ZnO in the glass composition is greater than or equal to 0.5 mol. % and less than or equal to 2.75 mol. %. In embodiments, the amount of ZnO in the glass composition is greater than or equal to 0.5 mol. % and less than or equal to 2.5 mol. %. In embodiments, the amount of ZnO in the glass composition is greater than or equal to 0.5 mol. % and less than or equal to 2.25 mol. %. In embodiments, the amount of ZnO in the glass composition is greater than or equal to 0.5 mol. % and less than or equal to 2.0 mol. %. In embodiments, the amount of ZnO in the glass composition is greater than or equal to 0.5 mol. % and less than or equal to 1.75 mol. %. In embodiments, the amount of ZnO in the glass composition is greater than or equal to 0.5 mol. % and less than or equal to 1.5 mol. %.

In the embodiments of the glass compositions in Composition Space B, the glass compositions may be substantially free of other constituent components including, without limitation, alkaline earth oxides (such as MgO, CaO, SrO, and BaO), P₂O₅, and Fe₂O₃.

Further, as noted hereinabove, the glass compositions of Composition Space B are chemically durable and resistant to degradation in acidic solutions, basic solutions, and water as determined by the acid test and the base test described herein, as well as the ISO 720 standard. The chemical durability of the glass compositions makes the glass compositions particularly well suited for use in applications in which the glass is contacted by liquids including, without limitation, acidic liquids, basic liquid, and water-based liquids.

The glass compositions of Composition Space B herein have an ISO 720 type HGA2 or a type HGA1 hydrolytic resistance. In embodiments, the glass compositions described herein may have an ISO 720 type HGA1 hydrolytic resistance. In embodiments, the glass compositions of Composition Space B may have a weight loss of less than 10 mg/cm², less than or equal to 1 mg/cm², or even less than or equal to 0.1 mg/cm² following exposure to the acid test. In embodiments, the glass compositions of Composition Space B may have a weight loss of less than 10 mg/cm², less than or equal to 5 mg/cm², or even less than or equal to 2 mg/cm² following exposure to the base test.

In the embodiments of the glass compositions of Composition Space B described herein, the glass compositions have an average coefficient of thermal expansion (CTE) of greater than or equal to 80×10⁻⁷/° C. and less than or equal to 92×10⁻⁷/° C. over the temperature range from 20° C. to 300° C. For example, in embodiments, the glass compositions have an average coefficient of thermal expansion (CTE) of greater than or equal to 85×10⁻⁷/° C. and less than or equal to 88×10⁻⁷/° C. over the temperature range from 20° C. to 300° C.

As noted herein, the glass compositions have softening points and molding temperatures which are relatively low. This improves the ease of remolding the glass compositions from stock materials to final form. These relatively low temperatures may also extend the service life of the molds which contact the glass as the lower molding temperatures reduce the oxidation of metal parts of the mold and minimize chemical reactions between the mold and the glass composition.

In the embodiments of the glass compositions of Composition Space B described herein, the glass compositions have softening points of less than or equal to 680° C. In embodiments, the glass compositions have softening points of less than or equal to 670° C. or even less than or equal to 660° C.

In the embodiments of the glass compositions of Composition Space B described herein, the glass compositions have molding temperatures of less than or equal to 620° C. In embodiments, the glass compositions have molding temperatures of less than or equal to 615° C., less than or equal to 610° C., or even less than or equal to 605° C.

The glass compositions of Composition Space B may generally have strain points greater than or equal to about 400° C. and less than or equal to about 500° C. or even greater than or equal to about 400° C. and less than or equal to about 450° C. The glass compositions may also have anneal points greater than or equal to about 400° C. and less than or equal to about 500° C. or even greater than or equal to about 450° C. and less than or equal to about 500° C.

In some embodiments, the glass compositions of Composition Space B may have liquidus viscosities greater than or equal to 90 kilopoise (kP) such that the glasses are compatible with sheet-forming processes (i.e., fusion drawing processes, slot draw processes, and the like).

The glass compositions of Composition Space A and Composition Space B are formed by mixing a batch of glass raw materials (e.g., powders of SiO₂, Al₂O₃, alkali oxides, alkaline earth oxides and the like) such that the batch of glass raw materials has the desired composition. Thereafter, the batch of glass raw materials is heated to form a molten glass composition which is subsequently cooled and solidified to form the glass composition. During solidification (i.e., when the glass composition is plastically deformable) the glass composition may be shaped using standard forming techniques to shape the glass composition into a desired final form. Alternatively, the glass article may be shaped into a stock form, such as a sheet, tube or the like, and subsequently reheated and formed into the desired final form, such as by molding or the like.

### EXAMPLES

The embodiments described herein will be further clarified by the following examples.

### Example 1

Samples of glass compositions from Composition Space A were melted and formed and the properties of the samples were measured or modeled (modeled values are indicated by “*”). The results are reported in Tables 1A, 1B, 2A, and 2B below. Acid consumption for ISO720 testing is reported as 0.02 mol/l HCl per gram of glass grains tested. Acid weight loss is reported following exposure of the glass samples to the acid test described herein. Base weight loss is reported following exposure of the glass samples to the base test described herein.

Samples 1-5 of Table 1A and samples 6-9 of Table 1B have liquidus viscosities of greater than 90 kP, indicating that the glass compositions of these samples may be compatible with sheet forming processes such as the fusion draw process and the slot draw process. The samples in Table 1A and Table 1B have relatively low softening points of less than 660° C. and relatively low molding temperatures of less than 630° C., indicating that these glass compositions can be readily remolded to form glass articles with 3-dimensional shapes with low risk of oxidizing the mold and/or reacting with the material of the mold. In addition, the samples in Table 1A and Table 1B have hydrolytic resistances of class HGA2 or class HGA1, indicating that these glass compositions do not readily degrade upon contact with aqueous solutions and, as such, these glasses are chemically durable despite having relatively low concentrations of Sift. Each of the samples in Tables 1A and 1B also have average coefficients of thermal expansion of less than 88×10⁻⁷/° C. averaged over the temperature range from about 20° C. to about 300° C.

While not wishing to be bound by theory, it is believed that the properties of the glass compositions identified in Tables 1A and 1B are due to the combination of constituent components in the glass and, in particular, to the content of ZnO in relation to the other modifiers. More specifically, additions of ZnO aided in reducing the softening points and molding temperatures of the glass compositions without significantly increasing the average coefficient of thermal expansion. For samples 1-9 in Tables 1A and 1B, limiting the ZnO content to less than 16 mol. % assisted in reducing the crystallization of the glass compositions and maintaining the liquidus viscosities of the glass compositions at levels greater than 90 kP. In addition, the use of mixed alkaline earth oxides or alkali oxides mixed with ZnO aided in reducing the softening points and the molding temperatures of the glass compositions and also aided in reducing the liquidus temperatures of the glass. Specifically, samples 3 and 5 (which did not contain alkaline earth oxides) had higher softening points, molding temperatures, and liquidus temperatures than glass compositions which included a combination of ZnO and alkaline earth oxides. In addition, it was found that the additions of ZnO improved the hydrolytic resistance of the glass composition according to ISO720.

TABLE 1A

| Sample/mol % | 1 | 2 | 3 | 4 | 5 |
|---|---|---|---|---|---|
| SiO₂ | 59.74 | 59.44 | 60.17 | 59.58 | 57.82 |
| Al₂O₃ | 0.48 | | | 0.47 | 0.47 |
| B₂O₃ | 15.47 | 16.41 | 16.74 | 14.68 | 14.92 |
| Na₂O | 9.45 | 10.89 | 10.96 | 11.97 | 14.22 |
| K₂O | 4.64 | 3.33 | 3.1 | 2.33 | |
| MgO | 1.96 | 0.96 | | 1.95 | |
| SrO | | | | | |
| ZnO | 8.23 | 8.92 | 8.89 | 9.01 | 11.09 |
| ZrO₂ | | | | | 1.44 |
| R₂O | 14.09 | 14.22 | 13.97 | 14.3 | 14.22 |
| RO | 1.96 | 0.96 | | 1.95 | |
| Avg. CTE (10⁻⁷/C.) | 86.3 | 86.1 | 83.8 | 85.2 | 77.4 |
| (20-300° C.) | | | | | |
| Strain (° C.) | 482.3 | 480.5 | 487.9 | 483.8 | 491.8 |
| Anneal (° C.) | 520.3 | 518.5 | 525.2 | 521.3 | 528.3 |
| Softening (° C.) | 656 | 653 | 657 | 655 | 659 |
| Molding (° C.) | 618 | 616 | 621 | 618 | 623 |
| Liquidus | <700 | 745 | 785 | <715 | 770 |
| temperature (° C.) | | | | | |
| Liquidus phase | | Quartz | Quartz | Na/K | Quartz |
| | | | | Feldspar | |
| Liquidus viscosity | >3.3 MP | 352 kP | 95 kP | 1.5 MP | 172 kP |
| ISO720 class | HGA2 | HGA2 | HGA2 | HGA2 | HGA2 |
| ISO720 HCl | | 0.19 | 0.13 | 0.15 | 0.11 |
| consumption | | | | | |
| Acid weight loss | 54 | 86 | 79 | 39 | 38 |
| [mg/cm²] | | | | | |
| Base weight loss | 4.38 | 4.54 | 4.58 | 4.05 | 1.02 |
| [mg/cm²] | | | | | |

TABLE 1B

| Sample/mol % | 6 | 7 | 8 | 9 | 10 |
|---|---|---|---|---|---|
| SiO₂ | 57.02 | 54.76 | 54.64 | 55.42 | 53.35 |
| Al₂O₃ | 0.47 | 0.47 | 0.47 | 0.48 | 0.47 |
| B₂O₃ | 12.92 | 14.97 | 14.98 | 14.14 | 15.46 |
| Na₂O | 12.48 | 11.06 | 12.02 | 11.94 | 13.25 |
| K₂O | 1.4 | 2.33 | 1.40 | 1.86 | |
| MgO | 1.94 | | 1.95 | 1.0 | |
| SrO | 0.99 | 1.97 | 1.98 | 1.41 | 0.98 |
| ZnO | 12.75 | 14.42 | 12.53 | 13.66 | 15.96 |
| ZrO₂ | | | | | 0.48 |
| R₂O | 13.52 | 13.39 | 14.42 | 13.8 | 13.25 |
| RO | 1.93 | 1.97 | 3.93 | 2.41 | 0.98 |
| Avg. CTE (10⁻⁷/C.) | 83.1 | 82.9 | 83.4 | ~83* | 78.3 |
| (20-300° C.) | | | | | |
| Strain (° C.) | 481.3 | 478 | 480.4 | ~478* | 480.1 |
| Anneal (° C.) | 518.1 | 514.6 | 517.2 | ~515* | 516.2 |
| Softening (° C.) | 647 | 640 | 635 | <640* | 636 |
| Molding (° C.) | 611 | 603 | 602 | 605* | 603 |
| Liquidus | 735 | <645 | 720 | | 810 |
| temperature (° C.) | | | | | |
| Liquidus phase | | | Willemite | | Willemite |
| Liquidus viscosity | 383 kP | >1.5 MP | ~315 kP | >300 kP* | 13 kP |
| ISO720 class | HGA2 | HGA2 | HGA2 | HGA2 | HGA1 |
| ISO720 HCl | 0.13 | 0.13 | 0.17 | | 0.090 |
| consumption | | | | | |
| Acid weight loss | 61 | 118 | 109 | | 120 |
| [mg/cm²] | | | | | |
| Base weight loss | 3.26 | 3.3 | 3.43 | | 2.75 |
| [mg/cm²] | | | | | |

Samples 11-20 of Tables 2A and 2B have lower liquidus viscosities compared to samples 1-9 in Tables 1A and 1B. In particular, the samples in Tables 2A and 2B have liquidus viscosities of less than 50 kP. It is believed that these lower liquidus viscosities are due to the higher content of ZnO in the samples of Tables 2A and 2B. Without wishing to be bound by theory, it is believed that the higher amount of ZnO in these glass compositions results in the formation of the zinc silicate Willemite (Zn₂SiO₄) in the liquidus phase. It is believed that the Willemite phase falls out of solution easily, thereby decreasing the liquidus viscosity.

In addition to having low liquidus viscosities, the samples in Tables 2A and 2B also have relatively low softening points of less than 660° C. and relatively low molding temperatures of less than 620° C., indicating that these glass compositions can be readily remolded to form glass articles with 3-dimensional shapes with low risk of oxidizing the mold and/or reacting with the material of the mold. As with the liquidus viscosities, it is believed that the lower molding temperatures of these samples relative to the samples in Tables 1A and 1B is due, at least in part, to the relatively higher concentration of ZnO in the samples of Tables 2A and 2B.

The samples in Table 2A and Table 2B have hydrolytic resistances of class HGA2 or class HGA1, indicating that these glass compositions do not readily degrade upon contact with aqueous solutions and, as such, these glasses are chemically durable despite having relatively low concentrations of SiO₂. For all the glass compositions in Tables 1A-2B, it is believed that the improvement in the hydrolytic resistance of the glass despite the relatively low SiO₂ concentration is due, at least in part, to the addition of ZnO to the glass compositions.

Each of the samples in Table 2A and Table 2B also have average coefficients of thermal expansion of less than 88×10⁻⁷/° C. averaged over the temperature range from about 20° C. to about 300° C.

TABLE 2A

| Sample/mol % | 11 | 12 | 13 | 14 | 15 |
|---|---|---|---|---|---|
| SiO₂ | 49.98 | 58.94 | 53.22 | 53.42 | 50.02 |
| Al₂O₃ | 0.46 | 0.47 | 0.46 | 0.47 | 0.47 |
| B₂O₃ | 14.72 | 7.63 | 15.55 | 16.31 | 16.68 |
| Na₂O | 10.42 | 13.23 | 13.29 | 13.24 | 11.67 |
| K₂O | 2.34 | 0.00 | 0.00 | 0.00 | 1.70 |
| MgO | 1.97 | 0.00 | 0.96 | 0.00 | 1.96 |
| SrO | 0.00 | 0.00 | 0.00 | 0.97 | 1.58 |
| ZnO | 20.08 | 19.71 | 16.00 | 15.05 | 15.87 |
| ZrO₂ | 0.00 | 0.00 | 0.49 | 0.49 | 0.00 |
| R₂O | 12.76 | 13.23 | 13.29 | 13.24 | 13.37 |
| RO | 1.97 | 0 | 0.96 | 0.97 | 3.54 |
| ZnO/R₂O | 1.63 | 1.49 | 1.20 | 1.14 | 1.19 |
| Avg. CTE (10⁻⁷/C.) | 80.6 | 79 | 78.7 | 80 | 84.1 |
| (20-300° C.) | | | | | |
| Strain (° C.) | 465.1 | 486.8 | 476.7 | 481.5 | 473.1 |
| Anneal (° C.) | 500.4 | 523.2 | 512.3 | 516.8 | 508.9 |
| Softening (° C.) | 623 | 656 | 634 | 638 | 623 |
| Molding (° C.) | 589 | 618 | 601 | 605 | 592 |
| Liquidus temperature | 930 | 925 | 840 | 785 | 815 |
| (° C.) | | | | | |
| Liquidus phase | Willemite | Willemite | Willemite | Willemite | Willemite |
| | Zn₂SiO₄ | | | | |
| Liquidus viscosity | 500 P | 3.5 kP | 6.0 kP | 31.6 kP | 5.9 kP |
| ISO720 class | HGA1 | HGA2 | HGA1 | HGA1 | |
| ISO720 HCl | 0.08 | 0.11 | 0.10 | 0.095 | |
| consumption | | | | | |
| Acid weight loss | 147 | 31 | 112 | 119 | 165 |
| [mg/cm²] | | | | | |
| Base weight loss | 6.2 | 3.6 | 3.5 | 2.5 | 4.6 |
| [mg/cm²] | | | | | |

TABLE 2B

| Sample/mol % | 16 | 17 | 18 | 19 | 20 |
|---|---|---|---|---|---|
| SiO₂ | 50.01 | 49.99 | 50.07 | 51.06 | 51.72 |
| Al₂O₃ | 0.47 | 0.47 | 0.47 | 0.47 | 0.47 |
| B₂O₃ | 19.60 | 14.96 | 15.09 | 14.99 | 15.96 |
| Na₂O | 11.61 | 10.62 | 11.84 | 11.82 | 12.02 |
| K₂O | 1.88 | 2.36 | 1.13 | 1.13 | 1.13 |
| MgO | 1.94 | 0.00 | 1.45 | 1.96 | 1.94 |
| SrO | 0.99 | 1.97 | 2.45 | 1.98 | 1.98 |
| ZnO | 13.45 | 19.57 | 17.45 | 16.55 | 14.73 |
| ZrO₂ | 0.00 | 0.00 | 0.00 | 0.00 | 0.00 |
| R₂O | 13.49 | 12.98 | 12.97 | 12.95 | 12.02 |
| RO | 1.93 | 1.97 | 3.90 | 3.94 | 3.92 |
| ZnO/R₂O | 0.97 | 1.51 | 1.37 | 1.28 | 1.23 |
| Avg. CTE (10⁻⁷/C.) | 83.8 | 84.4 | 83 | 82.8 | 83.8 |
| (20-300° C.) | | | | | |
| Strain (° C.) | 471 | 470 | 476 | 474.2 | 477.5 |
| Anneal (° C.) | 506.4 | 504.5 | 511.7 | 509.8 | 513.4 |
| Softening (° C.) | 621 | 620 | 627 | 627 | 627 |
| Molding (° C.) | 590 | 588 | 596 | 595 | 595 |
| Liquidus temperature | 780 | 900 | 830 | 815 | 785 |
| (° C.) | | | | | |
| Liquidus phase | Willemite | Willemite | Willemite | Willemite | Unknown |
| Liquidus viscosity | 15.6 kP | 1.1 kP | 4.1 kP | 7.1 kP | 17.6 kP |
| ISO720 class | | | | | |
| ISO720 HCl | | | | | |
| consumption | | | | | |
| Acid weight loss | 154 | 167 | 163 | 155 | 145 |
| [mg/cm²] | | | | | |
| Base weight loss | 5.2 | 4.9 | 4.2 | 4.0 | 4.2 |
| [mg/cm²] | | | | | |

### Example 2

Samples of glass compositions from Composition Space B were melted and formed and the properties of the samples were measured or modeled (modeled values are indicated by “*”). The results are reported in Table 3 below. Acid consumption for ISO720 testing is reported as 0.02 mol/l HCl per gram of glass grains tested. Acid weight loss is reported following exposure of the glass samples to the acid test described herein. Base weight loss is reported following exposure of the glass samples to the base test described herein.

Samples 21-26 of Table 3 have liquidus viscosities of greater than 200 kP, indicating that the glass compositions of these samples are compatible with sheet forming processes such as the fusion draw process and the slot draw process. The samples in Table 3 have relatively low softening points of less than 680° C. and relatively low molding temperatures of less than 620° C., indicating that these glass compositions can be readily remolded to form glass articles with 3-dimensional shapes with low risk of oxidizing the mold and/or reacting with the material of the mold. In addition, the samples in Table 3 have hydrolytic resistances of class HGA2, indicating that these glass compositions do not readily degrade upon contact with aqueous solutions and, as such, these glasses are chemically durable despite having relatively low concentrations of SiO₂. Each of the samples in Table 3 also have average coefficients of thermal expansion of less than 92×10⁻⁷/° C. averaged over the temperature range from about 20° C. to about 300° C.

While not wishing to be bound by theory, it is believed that the relatively low softening points and molding temperatures of the glass compositions identified in Table 3 are due to the addition of F₂ to the glass compositions. Specifically, each of the glass compositions in Table 3 have relatively high concentrations of SiO₂. As noted herein, the softening points and molding temperatures of glass compositions generally increase with increases in the concentration of SiO₂. However, in the samples of Table 3, the softening points and molding temperatures of the glass compositions were maintained at relatively low values. In particular, the molding temperatures of the samples in Table 3 were similar to the molding temperatures of the glasses identified in Tables 1A-2B despite having considerable higher concentrations of SiO₂.

TABLE 3

| Sample/mol % | 21 | 22 | 23 | 24 | 25 | 26 |
|---|---|---|---|---|---|---|
| SiO₂ | 72.83 | 73.14 | 73.00 | 71.69 | 69.89 | 71.53 |
| Al₂O₃ | 6.25 | 6.29 | 6.29 | 6.16 | 5.99 | 6.15 |
| B₂O₃ | 0.49 | 0.49 | 0.49 | 2.35 | 4.16 | 0.87 |
| P₂O₅ | 0.00 | 0.00 | 0.00 | 0.00 | 0.00 | 0.00 |
| Li₂O | 0.00 | 0.00 | 0.00 | 0.00 | 0.00 | 0.00 |
| Na₂O | 15.69 | 14.79 | 12.97 | 15.40 | 15.10 | 15.32 |
| K₂O | 0.88 | 1.77 | 3.57 | 0.87 | 0.85 | 0.87 |
| MgO | 0.00 | 0.00 | 0.01 | 0.00 | 0.00 | 0.00 |
| CaO | 0.01 | 0.01 | 0.01 | 0.01 | 0.01 | 0.01 |
| Fe₂O₃ | 0.005 | 0.005 | 0.006 | 0.005 | 0.005 | 0.005 |
| ZnO | 0.002 | 0.001 | 0.002 | 0.002 | 0.001 | 1.654 |
| F₂ | 3.78 | 3.45 | 3.61 | 3.45 | 3.95 | 3.54 |
| Strain (° C.) | 425.9 | 427.0 | 423.5 | 439.2 | 451.8 | 437.6 |
| Anneal Pt (° C.) | 465.1 | 466.4 | 462.6 | 478.3 | 491.4 | 475.4 |
| Soft Pf PPV (° C.) | 658.6 | 676.4 | xtl | 666.6 | 670.2 | 662.9 |
| CTE (10⁻⁷/° C. | 86.1 | 87.9 | 91 | 85.5 | 85 | 87.9 |
| 20-300° C. | | | | | | |
| Density (g/cm³) | 2.414 | 2.415 | 2.416 | 2.435 | 2.448 | 2.45 |
| Molding (° C.) | 604 | 606 | 604 | 613 | 619 | 612 |
| Liquidus Temp (° C.) | 835 | 810 | 830 | 820 | 815 | 850 |
| Liquidus Phase | Albite | Albite | K/Na Felds | Albite | Albite | Albite |
| Liquidus Viscosity | 276.9 | 506.9 | 565.7 | | 399.8 | 213.5 |
| (kP) | | | | | | |
| ISO 720 | HGA2 | HGA2 | HGA2 | HGA2 | HGA2 | HGA2 |
| Acid weight loss 5% | 0.033 | 0.026 | 0.024 | 0.025 | 0.032 | 0.029 |
| HCl 95° C. 24 hrs | | | | | | |
| (mg/cm²) | | | | | | |
| Base weight loss 5% | 1.795 | 1.820 | 1.789 | 1.785 | 1.822 | 1.507 |
| NaOH 95° C. 6 hrs | | | | | | |
| (mg/cm²) | | | | | | |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A glass composition comprising:
greater than or equal to 48 mol. % and less than or equal to 61 mol. % SiO₂;
greater than or equal to 0 mol. % and less than or equal to 1 mol. % Al₂O₃;
greater than or equal to 7 mol. % and less than or equal to 20 mol. % B₂O₃;
greater than or equal to 9 mol. % and less than or equal to 16 mol. % R₂O, where R₂O is a sum of alkali oxides present in the glass composition;
greater than or equal to 9 mol. % and less than or equal to 15 mol. % Na₂O; and
greater than or equal to 8 mol. % and less than or equal to 21 mol. % ZnO, wherein:
the glass composition is substantially free of Li₂O;
RO (mol. %)<0.5×ZnO (mol. %), where RO is a sum of the alkaline earth oxides MgO, CaO, BaO, and SrO in the glass composition;
an average coefficient of thermal expansion of the glass composition is greater than or equal to 75×10⁻⁷/° C. and less than or equal to 88×10⁻⁷/° C. over a temperature range from about 20° C. to about 300° C.,
the glass composition comprises a softening point less than or equal to 660° C.; and
the glass composition comprises a hydrolytic resistance of class HGA1 or class HGA2 according to ISO 720:1985.

2. The glass composition of claim 1, wherein:
SiO₂ is greater than or equal to 52 mol. % and less than or equal 61 mol. %;
B₂O₃ is greater than or equal to 12 mol. % and less than or equal to 17 mol. %; and
ZnO is greater than or equal to 8 mol. % and less than or equal to 16 mol. %.

3. The glass composition of claim 2, wherein Al₂O₃ is greater than 0.1 mol. % and less than or equal to 1.0 mol. %.

4. The glass composition of claim 2, wherein B₂O₃ is greater than or equal to 12 mol. % and less than or equal to 15 mol. %.

5. The glass composition of claim 2, wherein R₂O is less than or equal to 15 mol. %.

6. The glass composition of claim 2, wherein Na₂O is greater than or equal to 9 mol. % and less than or equal to 13 mol. %.

7. The glass composition of claim 2, wherein ZnO is greater than or equal to 9 mol. % and less than or equal to 15 mol. %.

8. The glass composition of claim 2 further comprising greater than or equal to 1 mol. % and less than or equal to 5 mol. % K₂O.

9. The glass composition of claim 2, wherein the glass composition is substantially free of K₂O.

10. The glass composition of claim 2, wherein RO is less than or equal to 5 mol. %.

11. The glass composition of claim 2, wherein a total amount of MgO (mol. %)+SrO (mol. %) is greater than or equal to 0.5 mol. % and less than or equal to 4 mol. %.

12. The glass composition of claim 2 further comprising greater than or equal to 0.5 mol. % and less than or equal to 2.5 mol. % SrO.

13. The glass composition of claim 2, wherein the glass composition is substantially free of SrO.

14. The glass composition of claim 2 further comprising greater than or equal to 0.5 mol. % and less than or equal to 2.5 mol. % MgO.

15. The glass composition of claim 2, wherein the glass composition is substantially free of MgO.

16. The glass composition of claim 2, wherein the glass composition comprises greater than 0.1 mol. % and less than or equal to 1.5 mol. % of at least one of TiO₂ and ZrO₂.

17. The glass composition of claim 2, wherein the glass composition comprises a liquidus viscosity of greater than 90 kilopoise (kP).

18. The glass composition of claim 2, wherein the glass composition has a weight loss of less than or equal to 10 mg/cm² according to at least one of the base test or the acid test.

19. The glass composition of claim 1, wherein:
SiO₂ is greater than or equal to 48 mol. % and less than or equal 55 mol. %; and
ZnO is greater than or equal to 13 mol. % and less than or equal to 21 mol. %, wherein a ratio of ZnO (mol. %) to R₂O (mol. %) is greater than or equal to 0.75 and less than or equal to 2.0.

20-33. (canceled)

34. A glass composition comprising:
greater than or equal to 66 mol. % and less than or equal to 74 mol. % SiO₂;
greater than or equal to 3 mol. % and less than or equal to 7 mol. % Al₂O₃;
greater than or equal to 11 mol. % and less than or equal to 23 mol. % R₂O, where R₂O is a sum of alkali oxide (mol. %) present in the glass composition;
greater than or equal to 11 mol. % and less than or equal to 18 mol. % Na₂O; and
less than or equal 3.0 mol. % ZnO;
greater than 2.5 mol. % and less than or equal to 5 mol. % F₂, wherein:
the glass composition is substantially free of Li₂O;
an average coefficient of thermal expansion of the glass composition is greater than or equal to 80×10⁻⁷/° C. and less than or equal to 92×10⁻⁷/° C. over a temperature range from about 20° C. to about 300° C.;
the glass composition comprises a softening point less than or equal to 680° C.; and
the glass composition comprises a hydrolytic resistance of class HGA1 or class HGA2 according to ISO 720:1985.

35-39. (canceled)
